(19) United States
(12) Patent Application Publication
(10) Pub. No.: US 2019/0207807 A1
(43) Pub. Date: Jul. 4, 2019

(54) METHOD AND SYSTEM FOR DETERMINING AND LOCATING NODAL WEAKNESSES IN A NETWORK

(71) Applicant: ELEMENTUM SCM (CAYMAN) LTD., GRAND CAYMAN (KY)

(72) Inventors: Nader Mikhail, Mountain View, CA (US); Dana Martin, Sunnyvale, CA (US); Olivier Bouan, Mountain View, CA (US); Adi Schlank, Los Altos, CA (US); Dean Ocampo, Oakland, CA (US)

(21) Appl. No.: 15/089,149

(22) Filed: Apr. 1, 2016

Related U.S. Application Data
(60) Provisional application No. 62/142,102, filed on Apr. 2, 2015.

(51) Int. Cl. H04L 12/24

(52) U.S. Cl. CPC H04L 41/0677; H04L 41/22

(57) ABSTRACT

The present disclosure discloses a network management system that can identify weaknesses at one or more nodes in a network. Weaknesses include possible single points of failure, risks associated with one or more nodes, and/or other factors corresponding to a node, an output of a node, a location of a node, a subsequent use of the output from a node, a reliance upon the output of a node by one or more other nodes, and/or combinations thereof.

### BENEFIT CLAIM

This application claims the benefit of provisional application 62/142,102, filed Apr. 2, 2015, the entire contents of which is hereby incorporated by reference as if fully set forth herein, under 35 U.S.C. §119(e).

### FIELD

The disclosure relates generally to automated systems for analyzing the impact of an event on a network.

### BACKGROUND

The traditional structure of the business supply and/or logistics chain, which viewed supply and/or logistics chain management as a chain of events, is evolving, in response to the ever-complicated logistics of modem trade, commerce and communications, towards viewing supply and/or logistics chain management as a three-dimensional model. In other words, organizations no longer view supply networks as a linear relationship between raw materials and distributors. Rather, today's supply web resembles a three-dimensional construct, complete with a variety of suppliers, tiers and intermediaries that serve to fill in for one another in the event of a disruption.

Increasingly, how well a supply web creates and shares information not only defines how well the web holds together, how efficiently it operates, and how much value it adds but also determines the success or failure—as a group—of the manufacturing venture. Companies need to share supply metrics, timelines, demand and capacity data to enable the supply network to develop a common and aligned set of objectives, which can protect it against commodity pressures, volatility and individual failures. Sharing information can speed up supply and/or logistics chains while mitigating the inherent risks in doing so. This new model, with cost management at its core, can capture decades of best practices in a unified strategy for a new generation of companies and managers.

Although significant advances have been made towards establishing a three-dimensional supply chain by companies such as E2open™, GT Nexus™, and Resilinc™, problems remain. Many three-dimensional supply and/or logistics chains are fairly rigid and unable to respond dynamically to, let alone anticipate, adverse events. This can cause disruption in the supply and/or logistics chain and concomitant interruptions in the product distribution chain. They also fail to provide users with the supply and/or logistics chain information necessary to mitigate the impact of events quickly, efficiently, and effectively.

### SUMMARY

These and other needs are addressed by the various aspects, embodiments, and/or configurations of the present disclosure. The present disclosure generally discloses a network management system that can identify weaknesses at one or more nodes in a network, such as a distributed processing network. Weaknesses may include possible single points of failure, risks associated with one or more nodes, and/or other factors corresponding to a node, an output of a node, a location of a node, a subsequent use of the output from a node, a reliance upon the output of a node by one or more other nodes, and/or combinations thereof.

In some embodiments, the present disclosure may identify possible single points of failure (SPOF) in a network and/or parts of a network having a risk to an operational state of the network in the event a failure occurred at that part of the network. Identification can include identifying the location of the part of the network (e.g., node location, site identification, name, etc.). Additionally or alternatively, the present disclosure may generate a risk value for the part of the network corresponding to a potential impact that the part of the network may have on the entire network in the event that the part suffered a possible failure.

In one embodiment, nodes and/or edges of a network may be analyzed for possible SPOFs that would impact the operation of the network. A node may correspond to an object supply node in a network. It should be appreciated that the object may refer to a tangible and/or material thing and/or a data construct that provides information used in a computer network. The object may be data, data sets, bits, materials, parts, products, components, etc., and/or combinations thereof. By way of example, and in the context of a supply and/or logistics chain, the node may be equivalent to a supplier, a physical location, a part, and/or a product. An edge may refer to a transportation and/or logistics network that connect two or more nodes. Continuing the supply and/or logistics chain example provided above, the edge may correspond to a transportation path between the supplier and a destination. In any event, the edges may define a relationship between two or more nodes in the network.

The dependency of the network on a particular part of the network (e.g., a node, an edge, etc.) can serve to indicate a particular SPOF of the network. For instance, the number of outputs provided by one or more object supply nodes may be analyzed based on how many receiving nodes are using the outputs. Additionally or alternatively, each output may be analyzed to determine whether the output is unique to a particular object supply node. Object supply nodes providing a unique output (e.g., an output that is not and/or cannot be provided by another object supply node, etc.) may provide a greater risk to the operation of the network in the event of a failure. This risk may be based on the output and/or a demand for the output. For instance, if the object supply node provides a scarce or complex part and fails to provide that scarce or complex part, receiving nodes that require the output may fail to operate.

In a supply and/or logistics chain example, the present disclosure provides using an outcome based risk management approach in analyzing a number of supplier nodes, determining how many of the parts provided by those nodes are included in more than one product, and ranking the parts and sites based on how interconnected they are to delivering finished goods to customer and/or end user. This approach may include determining how many products the parts from a site go into. The method may proceed by determining whether any previously qualified alternatives exist for those parts. Optionally, variables may be used in determining a rank and/or importance of the node within the network. These variables may include, but are not limited to, how much profit is derived from the parts that are made at the site for the products they go into, how long it takes for a site to recover from a typical disruption or failure, what is the lead time to get parts, how complex or scarce is the type of part, what is the demand for the part on an ongoing basis, etc. For example, the parts and/or suppliers may be ranked by their risk, or potential risk, to the network.

In some embodiments, a rank and/or risk of an output provided by an object supply node within a network may be generated based on a geographical location associated with the object supply node and/or an edge connected to at least one object supply node. For instance, while a particular object supply node may have an alternative supply node and not appear to be a risk, both the particular object supply node and the alternative supply node may be located in the same geographical region (e.g., southern Japan). In the event of a predicted and/or actual extreme environmental condition (EEC) such as an earthquake, flooding, hurricane, tsunami, typhoon, tornado, etc., and/or combinations thereof in the geographical region, the apparent low risk nodes may become high risk nodes. In one embodiment, the supply node risk analyzer disclosed herein may consider geographical location, relationships between locations, transportation pathways, etc., in determining a risk for one or more of a node, edge, and/or an output from a node. Similarly, while an object supply node may be located in a geographical region having few recorded and/or predicted EECs, an edge associated with the object supply node may pass through a geographical region known for EECs. This information may be used by the supply node risk analyzer to rank the node, edge, and/or an output of the node as having an increased risk.

The risk and/or ranking of a node, an edge, and/or an output of a node may be based on a number of factors including, but in no way limited to, geography, weather, EECs, season, frequency of historical issues, geopolitical factors, scarcity of supply, market trends, Internet trends, social media trends, etc., and/or combinations thereof. The factors may correspond to a node, an edge, an output of a node, a surrounding node, etc.

The present disclosure offers a number of advantages and benefits including, but not limited to, determining a rank and/or a risk associated with one or more nodes in a network, determining any nodes that may be a SPOF in a network prior to a failure, arranging alternative object supply nodes based on the identification, rank and/or risk associated with a node, and generating a network of nodes having a distributed risk and alternative distributed supplies to name a few.

This disclosure is intended to encompass the method of operation and tangible and non-transient computer readable medium containing microprocessor executable instructions to perform the operations of each of the communication device and server.

The present disclosure can provide a number of advantages depending on the particular aspect, embodiment, and/or configuration. The supply and/or logistics chain management system can, particularly for vertically integrated supply and/or logistics chains, more effectively and efficiently control suppliers, prices, product supply, and other terms, generate faster material turns or velocities, increase profit, enable leaner manufacturing and

logistics operations, and reduce waste when compared to a supply and/or logistics chain without the supply and/or logistics chain management system. It can more effectively consider the impact of unanticipated or “black swan” events, including natural and manmade disasters, by monitoring news sources, law enforcement and military authorities, among others, and precisely map tier 1, 2, 3, and 4 facilities. It can effectively assess the sensitivity of the supply and/or logistics chain to various internal and external events. It can assess the risk of having a particular product or product component available at a selected location at a selected price or cost. It can enable greater levels of collaboration not only among the various tiers but also within tiers of the supply and/or logistics chain. It can enable more effective management of multiple sources, within a given tier, even for legally distinct, competitive entities. Ranking the items, impacted by an event, against one another enables the user to know which is a more significant impact to the corresponding supply and/or logistics chain. The “relative” aspect takes this algorithm from a generic risk analysis to a risk analysis configured for a selected set of circumstances. The system's combination of cloud tools, operating models, and risk management logic can create new, more profitable and effective business practices in three-dimensional supply and/or logistics chains.

Embodiments include a method, comprising: determining a number of nodes in a network; determining an output provided by each of the nodes; determining at least one receiving node for the output provided by each of the nodes connected via at least one edge; ranking, via a processor, each of the nodes based at least partially on the output provided and a number of receiving nodes for the output provided; and providing the rank of one or more nodes in the network to one or more communication devices associated with a user of the network. Aspects of the above method include wherein prior to ranking each of the nodes, the method further comprises: determining whether a specific output provided by a single node in the number of nodes is unique to the single node; and identifying, when the specific output is unique to the single node, the single node as a single point of failure (SPOF) for the network. Aspects of the above method further comprise determining a risk level for each of the nodes in the network, and wherein providing the rank includes providing the risk level for the one or more nodes in the network. Aspects of the above method include wherein each of the nodes corresponds to a part, component, and/or product, wherein the network is a supply and/or logistics chain, wherein the at least one receiving node is a manufacturing plant, storage site, and/or assembly plant, and wherein the edges are transportation routes or relationship connectors. Aspects of the above method include wherein the risk level indicates whether the node is a SPOF. Aspects of the above method further comprise determining whether any alternative nodes exist in the network configured to provide an alternative output to the unique output provided by the single node. Aspects of the above method further comprise analyzing, when alternative nodes exist, qualification factors associated with at least one of the alternative nodes and the alternative output provided by the alternative nodes; and identifying, based on the analysis, specific alternative nodes having a predetermined number of the qualification factors, the identification indicating that the alternative output provided by the specific alternative node is configured as a substitute for the unique output. Aspects of the above method include wherein the rank is at least partially based on the identification of the specific alternative nodes having the predetermined number of the qualification factors, and wherein the risk level of an SPOF is lowered from a high risk level to a lower risk level when the specific alternative nodes includes the predetermined number of the qualification factors. Aspects of the above method include wherein providing the rank includes presenting information to a display of the communication device, the information including a graphical representation of the rank of the one or more nodes in the network relative to one another.

Embodiments include a non-transitory computer readable medium having stored thereon instructions that, when executed by a processor, perform any of the methods described above.

Embodiments include a system, comprising: a processor; a memory; a network interface configured to receive incoming messages and send outgoing messages; and an interface driver to provide control signals to effect operation of the network interface, wherein the memory comprises: a processor executable supply node output analyzer configured to determine a number of nodes in a network, determine an output provided by each of the nodes, determine at least one receiving node for the output provided by each of the nodes connected via at least one edge; and a processor executable supply node risk analyzer configured to rank each of the nodes based at least partially on the output provided and a number of receiving nodes for the output provided, and provide a rank of one or more nodes in the network to one or more communication devices associated with a user of the network.

Embodiments include a computer display, comprising: a light source; a polarized substrate comprising a liquid crystal material positioned between at least first and second polarized glass layers; an electrical current source to provide electrical currents to cause the liquid crystal material to align to allow a selected level of light to pass through at least part of the substrate and provide a displayed image; and a display selector to control the light and electrical current sources to produce the displayed image, wherein a first portion of the displayed image contains a listing of nodes in a network having a rank based at least partially on a dependency of each node in the network and a type of output provided by each node

These and other advantages will be apparent from the disclosure.

The phrases “at least one,” “one or more,” and “and/or” are open-ended expressions that are both conjunctive and disjunctive in operation. For example, each of the expressions “at least one of A, Band C,” “at least one of A, B, or C,” “one or more of A, B, and C,” “one or more of A, B, or C” and “A, B, and/or C” means A alone, B alone, C alone, A and B together, A and C together, Band C together, or A, Band C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

“Automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

“Computer-readable medium” as used herein refers to any tangible and non-transient storage and/or transmission medium that participate in providing instructions to a processor for execution. Such a medium may take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium excludes transient storage media, particularly electrical, magnetic, electromagnetic, optical, magneto-optical signals.

A “database” is an organized collection of data held in a computer. The data is typically organized to model relevant aspects of reality (for example, the availability of specific types of inventory), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multivalue, semantic, and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented, and unstructured databases.

“Database management systems” (DBMSs) are specially designed applications that interact with the user, other applications, and the database itself to capture and analyze data. A general-purpose database management system (DBMS) is a software system designed to allow the definition, creation, querying, update, and administration of databases. Well-known DBMSs include MySQL™, PostgreSQL™, SQLite™, Microsoft SQL Server™, Microsoft Access™, Oracle™, SAP™, dBASE™, FoxPro™, and IBM DB2™. A database is not generally portable across different DBMS, but different DBMSs can inter-operate by using standards such as SQL and ODBC or JDBC to allow a single application to work with more than one database.

“Determine,” “calculate” and “compute,” and variations thereof, as used herein, may be used interchangeably and include any type of methodology, process, mathematical operation or technique.

A “display” refers to a computer output providing one or more computer generated image(s) to a user. The output is typically a liquid crystal display (“LCD”) or cathode ray tube (“CRT”). Liquid crystal display technology works by blocking light. Specifically, an LCD is made of two pieces of polarized glass (also called substrate) that contain a liquid crystal material between them. A backlight creates light that passes through the first substrate. At the same time, electrical currents cause the liquid crystal molecules to align to allow varying levels of light to pass through to the second substrate and create colors and images for the outputted image. Most LCD displays use active matrix technology. A thin film transistor (TFT) arranges tiny transistors and capacitors in a matrix on the glass of the display. To address a particular pixel, the proper row is switched on, and then a charge is sent down the correct column. Since all of the other rows that the column intersects are turned off, only the capacitor at the designated pixel receives a charge. The capacitor is able to hold the charge until the next refresh cycle. The other type of LCD technology is passive matrix. This type of LCD display uses a grid of conductive metal to charge each pixel. A CRT monitor contains millions of tiny red, green, and blue phosphor dots that glow when struck by an electron beam that travels across the screen to create a visible image. In a cathode ray tube, the “cathode” is a heated filament. The heated filament is in a vacuum created inside a glass “tube.” The “ray” is a stream of electrons generated by an electron gun that naturally pour off a heated cathode into the vacuum. Electrons are negative. The anode is positive, so it attracts the electrons pouring off the cathode. This screen is coated with phosphor, an organic material that glows when struck by the electron beam. Filtration of the electron beam to produce the outputted image can be done by one or more of shadow mask, aperture grill, and slot mask.

An “Electronic Product Code” (EPC) is designed as a universal identifier that provides a unique identity for every physical object anywhere in the world, for all time. Its structure is defined in the EPCglobal Tag Data Standard, which is an open standard freely available for download from the website of EPCglobal, Inc. The canonical representation of an EPC is a URI, namely the “pure-identity URI” representation that is intended for use when referring to a specific physical object in communications about EPCs among information systems and business application software. The EPCglobal Tag Data Standard also defines additional representations of an EPC identifier, such as the tag-encoding URI format and a compact binary format suitable for storing an EPC identifier efficiently within RFID tags (for which the low-cost passive RFID tags typically have limited memory capacity available for the EPCIUII memory bank). The EPCglobal Tag Data Standard defines the structure of the URI syntax and binary format, as well as the encoding and decoding rules to allow conversion between these representations. The EPC is designed as a flexible framework that can support many existing coding schemes, including many coding schemes currently in use with barcode technology. EPCs are not designed exclusively for use with RFID data carriers. They can be constructed based on reading of optical data carriers, such as linear bar codes and two-dimensional bar codes, such as Data Matrix symbols.

An “enterprise” refers to a business and/or governmental organization, such as a corporation, partnership, joint venture, agency, military branch, company, and the like.

“Enterprise resource planning” or ERP systems integrate internal and external management information across an entire organization, embracing finance/accounting, manufacturing, sales and service, customer relationship management, and the like. ERP systems automate this activity with an integrated software application. The purpose of ERP is to facilitate the flow of information between all business functions inside the boundaries of the organization and manage the connections to outside stakeholders.

“Kill shot,” “killshot,” and variations thereof, as used herein, may be used interchangeably and may refer to a possible single point of failure (SPOF) in a network. The SPOF may be associated with a particular rank and/or risk associated with a part of a network. The part of the network can include a node in the network and/or an output from a node in the network. The SPOF and/or “kill shot” may refer to a potential risk of the network, such that a single fault at a part of the network can cause the entire network to cease operating. A sole source supplier of a particular output is one example of an SPOF and/or kill shot in a network.

“Manufacturing process management” or MPM is a collection of technologies and methods used to define how products are to be manufactured. MPM differs from ERP/MRP, which is used to plan the ordering of materials and other resources, set manufacturing schedules, and compile cost data. A cornerstone of MPM is the central repository for the integration of all these tools and activities aids in the exploration of alternative production line scenarios; making assembly lines more efficient with the aim of reduced lead time to product launch, shorter product times and reduced work in progress (WIP) inventories as well as allowing rapid response to product or product changes.

“Material requirements planning” or MRP is a production planning and inventory control system used to manage manufacturing processes. Most MRP systems are software-based. An MRP system is intended to simultaneously meet three objectives, namely ensure materials are available for production and products are available for delivery to customers, maintain the lowest possible material and product levels in store, and plan manufacturing activities, delivery schedules and purchasing activities.

“Means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

“Module” as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

An “original equipment manufacturer”, or OEM, manufactures product or components that it sells to end users or another enterprise and retailed to end users under that purchasing enterprise's brand name. OEM generally refers to an enterprise that originally manufactured the final product for a purchaser, such as a consumer. For example, Ford™ and General Motors™ are OEM companies that manufacture cars, and Apple™ is a computer OEM. The brand owner may or may not be the OEM.

A “performance indicator” or “key performance indicator” (“KPI”) is a type of performance measurement. An organization may use KPIs to evaluate its success, or to evaluate the success of a particular activity in which it is engaged.

“Real-time locating systems” or RTLS are used to automatically identify and track the location of objects or people in real time, usually within a building or other contained area. Wireless RTLS tags are attached to objects or worn by people, and in most RTLS, fixed reference points receive wireless signals from tags to determine their location. Examples of real-time locating systems include tracking automobiles through an assembly line, locating pallets of merchandise in a warehouse, or finding medical equipment in a hospital. The physical layer of RTLS technology is usually some form of radio frequency (RF) communication, but some systems use optical (usually infrared) or acoustic (usually ultrasound) technology instead of or in addition to RF. Tags and fixed reference points can be transmitters, receivers, or both, resulting in numerous possible technology combinations. RF trilateration can use estimated ranges from multiple receivers to estimate the location of a tag. RF triangulation uses the angles at which the RF signals arrive at multiple receivers to estimate the location of a tag.

A “server” is a computational system (e.g., having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running. Servers typically include a network interface to receive incoming and send outgoing messages, a buffer for temporary storage of incoming and send outgoing messages, and an interface driver to provide the control signals to effect operation of the network interface and buffer.

A “supply and/or logistics chain” refers typically to a tiered supply chain. The chain commonly links business functions and processes in the chain into an integrated business model. Each enterprise in a tier supplies an enterprise in the next highest tier and is in tum supplied by an enterprise in the next lowest tier. For example, a tier two company supplies a tier one company, a tier three company supplies a tier two company, and so on.

A “tier one enterprise” supplies parts or components directly to an original equipment manufacturer (“OEM”), which typically sets up the supply and/or logistics chain. A tier one enterprise commonly has the skills and resources to supply the parts or components that an OEM needs, including having established processes for managing suppliers in the tiers below them. In some applications, tier one enterprises provide a manufacturing service for the OEM, leaving the OEM to concentrate on final product assembly and/or marketing.

A “tier two enterprise” is a supplier to a tier one enterprise and generally do not supply parts or components directly to the OEM. A single enterprise, however, may be a tier one enterprise supplier to one company and a tier two enterprise supplier to another company or may be a tier one enterprise supplier for one product and a tier two enterprise supplier for a different product line. Similar rules apply for enterprises in other tiers, such as tier three enterprises, tier four enterprises, and so on. For example, tier three enterprise suppliers supply directly to tier two enterprises and tier four enterprise suppliers supply directly to tier three enterprises. In many supply and/or logistic chains, tier four enterprise suppliers are providers of basic raw materials, such as steel and glass, to higher-tier enterprise suppliers.

A “warehouse management system” (WMS) is a part of the supply and/or logistics chain and controls the movement and storage of materials or inventory within a warehouse and processes the associated transactions, including shipping, receiving, putaway and picking. The systems can also direct and optimize stock putaway based on real-time information about the status of bin utilization. A WMS monitors the progress of products through the warehouse. It involves the physical warehouse infrastructure, tracking systems, and communication between product stations. Commonly, warehouse management involves the receipt, storage and movement of goods, (normally finished goods), to intermediate storage locations or to a final customer. In the multi-echelon model for distribution, there may be multiple levels of warehouses. This includes a central warehouse, a regional warehouses (serviced by the central warehouse) and potentially retail warehouses (serviced by the regional warehouses). Warehouse management systems often utilize automatic identification and data capture technology, such as barcode scanners, mobile computers, wireless LANs and potentially radio-frequency identification (RFID), to efficiently monitor the flow of products. Once data has been collected, there is either a batch synchronization with, or a real-time wireless transmission to a central database. The database can then provide useful reports about the status of goods in the warehouse.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of an exemplary three-dimensional supply and/or logistics chain;

FIG. 2 depicts a communications networked architecture according to an embodiment;

FIG. 3 depicts an example of a supply and/or logistics chain monitoring system;

FIG. 4 depicts a globally distributed supply and/or logistics chain according to an embodiment;

FIG. 5 is a block diagram of an exemplary exposure module;

FIG. 6 is a network diagram in accordance with embodiments of the present disclosure;

FIG. 7 is a flow or process diagram according to an embodiment;

FIG. 8 is a flow or process diagram according to an embodiment;

FIG. 9 is a screenshot according to an embodiment;

FIG. 10 is a screenshot according to an embodiment;

FIG. 11 is a screenshot according to an embodiment; and

FIG. 12 is a screenshot according to an embodiment.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference letter or label.

### DETAILED DESCRIPTION

The Supply and/or Logistics Chain Management System

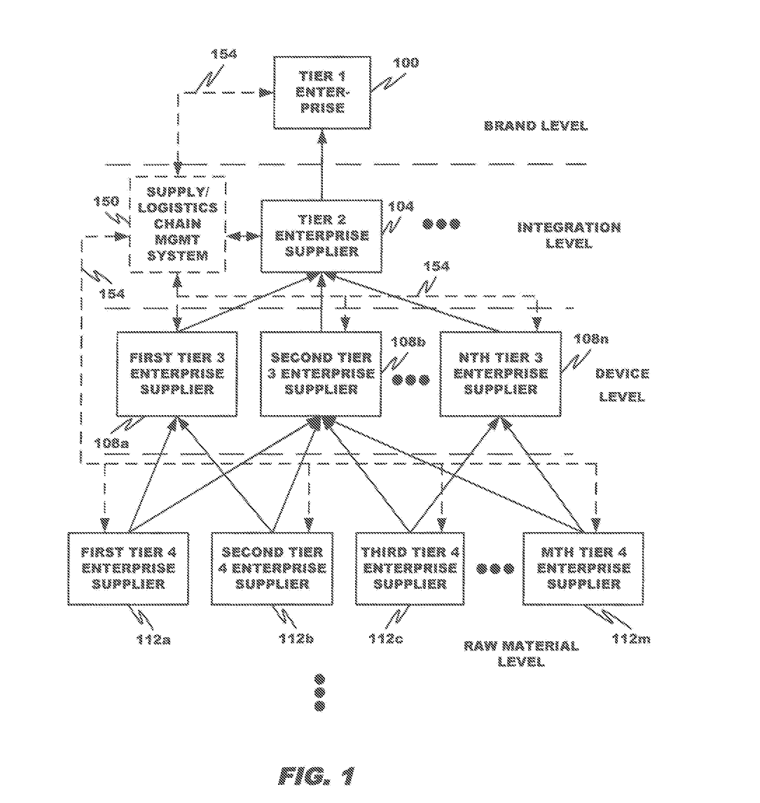

The supply and/or logistics chain management system 150 will be discussed with reference to FIG. 1. FIG. 1 illustrates a simplified supply and/or logistics chain and is not intended to be limiting for purposes of this disclosure. Generally, parts and components of products are made from materials and/or other parts and components, and finished goods or products are made from materials, parts, and/or components. Materials are generally considered to be raw materials, or crude or processed materials or substances.

A tier 1 enterprise 100, in a brand level, typically corresponds to an OEM that is also a brand owner, such as a retail and/or wholesale vendor, supplier, distributor, or other business that provides its branded products to end users. These businesses typically invest in research and development, product design, marketing, and brand development. Examples include Ford™ General Motors™, Toyota™, Apple™, Amazon™, Cisco Systems, Inc.™, and Microsoft Corporation™. The tier 1 enterprise 100 monitors (and collects information regarding) the supply and/or logistics chain, product inventory levels, product demand, and/or prices of competitive products and, based on the collected information and product demand and price projections, dictates to second tier enterprise partners, prices, supply requirements, and other material terms, and accesses performance information of such second and third tier enterprise partners to monitor supply and/or logistics chain performance.

A tier 2 enterprise supplier 104, in an integration level, assembles parts and/or components received from tier 3 enterprise suppliers 108a-n into products, which are shipped, by the tier 2 enterprise supplier 104, to the tier 1 enterprise 100 for manufacture and sale of finished goods or products. As will be appreciated, the tier 1 enterprise 100 can be an OEM. Tier 2 enterprise supplier(s) 104 provide, to the supply and/or logistics chain management system 150, its respective supply and/or logistics chain performance information and/or supply and/or logistics chain performance information received from tier 3 part and/or component enterprise suppliers.

The first, second, . . . nth tier 3 enterprise suppliers 108a-n, at the device level, manufacture parts and/or components for assembly by the tier 2 enterprise supplier 104 into products. The first, second, . . . nth tier 3 part and/or enterprise suppliers 108a-n provide, to the supply and/or logistics chain management system 150 or to the tier 2 enterprise supplier 104 for provision to the supply and/or logistics chain management system 150, its supply and/or logistics chain respective performance information and supply and/or logistics chain performance information received from tier 4 enterprise suppliers 112a-m.

The first, second, third, . . . mth tier 4 enterprise suppliers 112a-m, at the raw material level, manufacture and supply to the first, second, . . . nth tier 3 enterprise suppliers 108a-n materials for use in manufacturing parts and components for supply to the tier 2 enterprise supplier. The first, second, third, . . . mth tier 4 material suppliers 112a-m provide, to the supply and/or logistics chain management system 150 or to the tier 3 enterprise suppliers for provision to the supply and/or logistics chain management system 150, its respective supply and/or logistics chain performance information.

As shown by the ellipses at the bottom of FIG. 1, additional tiers of enterprise suppliers can exist depending on the application and industry.

The brand, integration, device and raw material levels are for purposes of illustration only and are not necessarily associated with the depicted tier. For example, the brand level may or may not be associated with the tier 1 enterprise(s) 100; the integration level may or may not be associated with the tier 2 enterprise supplier(s) 104; the device level may or may not be associated with the tier 3 enterprise supplier(s) 108a-n; and the raw material level may or may not be associated with the tier 4 enterprise supplier(s) 112a-m.

Each of the tier 1 enterprise 100, tier 2 enterprise supplier 104, first, second, third, . . . nth tier 3 enterprise suppliers 108a-n, and first, second, third, . . . mth tier 4 enterprise suppliers 112a-m correspond to an enterprise, which may or may not be related to or affiliated with another enterprise in the supply and/or logistics chain of FIG. 1.

As shown by the arrows, air, land, and sea logistics providers link the various tier partners with an integrated network of air, sea, and ground capabilities to enable effective movement of materials, components, and products from sources (or points of origination) to destinations.

As will be appreciated, each tier 1, 2, 3 and 4 enterprise can have one or more sites where a supply and/or logistics chain activity occurs. The sites can, for example, be a manufacturing, processing, or treatment facility such as a factory or plant, storage facility such as a warehouse, distribution facility, mine, farm, ranch, or other agricultural facility, and the like. The various sites can be co-located or distributed depending on the application.

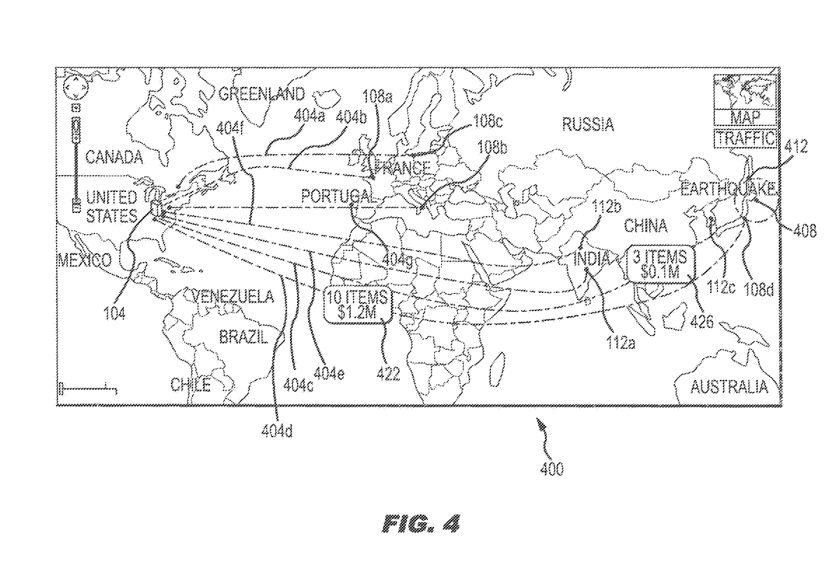

FIG. 4 (which can be a display outputted by the supply and/or logistics chain management system 150) is an illustration of a globally distributed supply and/or logistics chain 200. With reference to FIG. 4, locations of various supply and/or logistics chain sites, including the tier 2 enterprise supplier 104, first, second, . . . nth tier 3 enterprise suppliers.

108a-n, and first, second, third, . . . mth tier 4 enterprise suppliers 112a-m. Material and/or part and/or component and/or product shipment lines 200a-g between the various related nodes can be shown. Different colors or shades of a common color or line patterns or shading can be assigned to each shipment line to indicate on-time shipments, slightly delayed shipments, moderately delayed shipments, and heavily delayed shipments. Moving a cursor over a node, shipment line, or event can cause a box or icon, such as shown by boxes 422 and 426, to appear providing relevant information about the associated one of the node, shipment line, or event. For example, relevant information about the node can include enterprise and/or organization name, materials and/or part and/or component and/or products supplied by the enterprise, and one-hop related enterprises (e.g., the supplier to the selected node and the purchaser from the selected node). Relevant information about the shipment line can include the name of the freight carrier, number, type, and value of material and/or part and/or component and/or product currently being shipped, and the current status of the shipment. The boxes in FIG. 4 show relevant shipment information including a number and value of products, parts, and/or components currently en route along the corresponding shipment line.

With respect to FIG. 1, the supply and/or logistics chain management system 150, via communication links 154, monitors (and collects information regarding) first, second, third, fourth, . . . tier enterprises in the supply and/or logistics chain to determine supply and/or logistic chain performance information. Exemplary users of the system 150 include brand owners (e.g., retailers and wholesalers), and/or contract manufacturer and OEM representatives, such as a manufacturing representative, enterprise officers, and managers. Due to the adverse impact on the performance of the supply and/or logistics chain, the supply and/or logistics chain management system 150 can monitor for events potentially impacting adversely, or disrupting, supply and/or logistics chain performance.

“Supply and/or logistics chain performance information” typically includes any information relative to supply and/or logistics chain configuration and/or performance, including, without limitation, one or more of manufactured item output projections over a specified time period, production facility sizes and/or locations, raw material, work-in-process, and/or manufactured part, component, and/or product inventory levels, outstanding orders, order cycle times, days of supply in inventory, manufacturing resource type, availability, reliability, and/or productivity (e.g., human and automated resource levels and resulting output levels), unit operations (e.g., manufacturing steps, functions, or operations, unloading raw materials, packaging parts, components, and/or products, loading parts, components, and/or products, and the like), financial factors (e.g., labor rates and costs, energy rates and costs, raw materials costs, freight costs, tax rates, administrative and overhead costs, contractual and/or current spot market part, component, and/or product prices (from lower tier components), and the like), number of on time shipments, number of late shipments, order mismatch count, service quality (e.g., repair returns, repeat repair, no fault found, etc.), repair cost per unit (e.g., material cost per unit, average repair time, pieces consumed per unit, etc.), inventory value (e.g., spare parts stock, or SWAP stock, inventory turnover, days of supply of spare parts, days of supply of SWAP, days sales inventory spare parts, excess spare parts, excess SWAP stock, return to vendor rate, defective or OHB, and return to vendor or TAT, etc.), historic, current, and/or projected compliance with price, supply requirements, and/or other material terms, historic, current, and/or projected parts, components, and/or product output levels, mean, median and/or average, mode, historic, and/or projected freight transportation times, delays, or requirements, and the like. The performance information can be associated with a date, month, and/or season-of-year. KPI metrics can be generated from the performance information, such as on time shipment rate or percentage, late shipment rate or percentage, product rejection rate based on nonconformance with one or more restrictions, specifications, and/or requirements, parts, components, and/or product acceptance rate based on conformance with one or more restrictions, specifications, and/or requirements, and the like.

While the above example assumes that supply and/or logistics chain performance information is supplied to the nearest downstream partner, it is possible that one or more of the tier 2, 3, and 4 partners and/or logistic providers provide supply and/or logistics chain performance information directly to the supply and/or logistics chain management system 150. It is further to be understood that any number of entities, factories, plants, or other facilities may exist at each of the brand, integration, device, and raw material levels.

Inventory, whether a product or part or component of the product, can be tracked by the supply and/or logistics chain management system 150 manually or automatically or a combination thereof. A manual system, for example, is a system known as the card system or cardex. Other manual systems use a type of manual entry system to record inventory transactions and record the entries in a spreadsheet program rather than on a paper card. In automated systems, whenever a movement of inventory occurs, an inventory management system receives an automatic update of the transaction. Various tracking methods exist to track inventory. The barcode, also known as the universal product code (UPC), remains one of the most common inventory tracking methods. Barcodes can track the movement of inventory throughout the supply and/or logistics chain. The barcode contains data on the item's description, the item's price and the item's unit of measure. Radio frequency identification (RFID) is another method used to track inventory. RFID technology comes in two forms: active RFID and passive RFID. Active RFID works best in environments where security issues exist and ones that require real-time tracking information. Passive RFID works best when used with handheld scanners and where security issues do not exist. Electronic Product Codes may also be employed. Code or identifier sensors or readers are positioned throughout the supply and/or logistics chain, typically at entrance and exit points to a facility, such as a warehouse, to detect inventory movement and identify what inventory items have moved. The readers at each ingress or egress (or choke) point can be meshed auto-ID or hand-held ID applications. Tracking can also be capable of providing monitoring data without binding to fixed location by using a cooperative tracking capability, e.g. a real-time locating system or RTLS. In this way, the inventory tracking system can track the addition of items to an inventory and any disbursements from inventory.

The detected codes or identifiers can be fed into Work in Progress models (WIP) or Warehouse Management Systems (WMS) or ERP software. These models or modules can then provide the inventory information to the other supply and/or logistics chain members, such as the supply and/or logistics chain management system 150.

There are a number of examples of events impacting the performance of a selected supply and/or logistics chain. Events can include, for example, natural disasters (e.g., natural disaster event and wherein the natural disaster is one or more of an earthquake, tsunami, volcanic eruption, fire, flood, avalanche, and landslide), weather patterns (e.g., storm, typhoon, hurricane, cyclone, tornado, wind, flood, and blizzard), political disruptions (e.g., coup d'etat, revolutions, changes or upheavals, sabotage, terrorism, act of war, military action, police action, embargo, and blockade), criminal actions (e.g., piracy, hijacking, theft, arson, vandalism, and the like), acts of violence (e.g., terrorism, war, political upheaval, military action, and the like), freight disruptions (e.g., train derailment, maritime vessel sinking, airplane crash, freight embargo, freight vehicle wreck, naval blockades and the like), energy shortages, disruptions, or blackouts, business disruptions (e.g., device or system malfunction, labor disruption (e.g., strikes or threatened strikes)), lawsuit, financial insolvency, public announcement by a partner or competitor, scheduled event or holiday (e.g., religious, political, or other holidays), and bankruptcy), a human and/or animal health event, such as a health emergency, sickness, death, species endangerment, and/or species extinction caused by one or more of a pathogen, disease, virus, nano-virus, biological weapon, bacteria, parasite, worm, fungus, prion, and/or any other animal health-related outbreak, epidemic, pandemic, etc., and/or any other event that is external or internal to the supply and/or logistics chain (e.g. production quality issue, inventory stock shortage, manufacture system, device, or apparatus malfunction, or other event that demands or causes lead time within the supply and/or logistics chain).

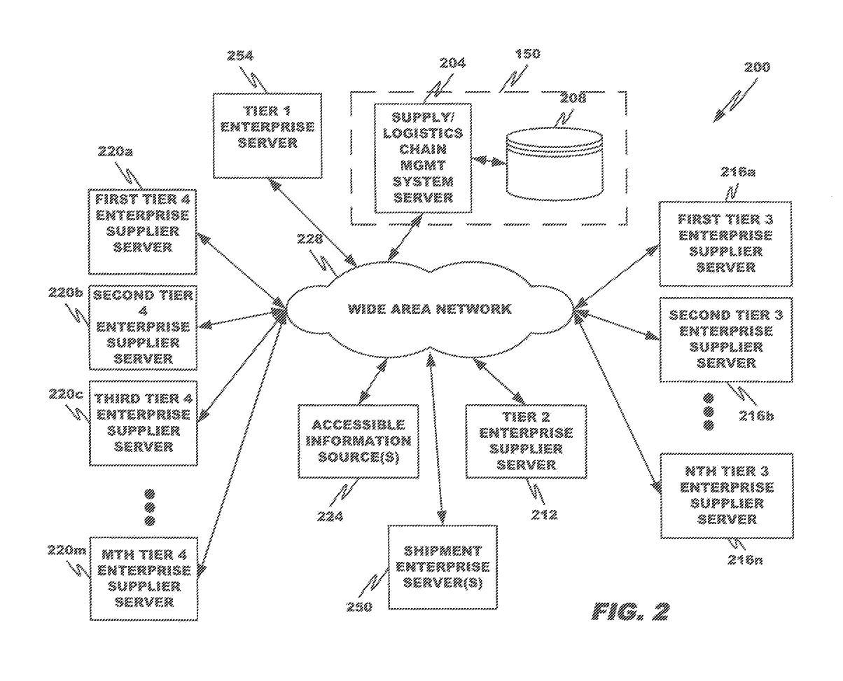

FIG. 2 depicts a communications networked architecture 200 according to an embodiment.

The supply and/or logistics chain management system 150 comprises a server 204 and associated database management system (not shown) and database 208. As will be appreciated, the supply and/or logistics chain management system 150 can be maintained by anyone of the tier 1, 2, 3, and/or 4 enterprises or an entity independent of the foregoing.

The supply and/or logistics chain management server 204 can be any computerized process that shares a resource with one or more client processes. It may run one or more services (typically as a host), to service the needs of other computers on the network. Typically, the supply and/or logistics chain management server 204 is a computer program running to serve the requests of other programs.

The database 208 can be any organized collection of data and their supporting data structures. The database can be based on any data model, including the relational model, entity-relationship model, object model, object relational model, XML, or other database model.

Referring again to FIG. 2, the tier 1 enterprise 100 can have a corresponding tier 1 enterprise supplier server 254 to provide supply and/or logistics chain performance and other information, directly or indirectly, to the supply and/or logistics chain management server 204.

The tier 2 enterprise supplier 104 can have a corresponding enterprise supplier server 212 to provide supply and/or logistics chain performance and other information, directly or indirectly, to the supply and/or logistics chain management server 204

Each of the first, second, . . . nth tier 3 enterprise suppliers 108a-n can have a corresponding tier 3 enterprise supplier server 216a-n to provide supply and/or logistics chain management performance and other information, directly or indirectly, to the supply and/or logistics chain management server 204.

Each of the first, second, third, . . . mth tier 4 enterprise suppliers 112a-m can have a corresponding tier 4 enterprise supplier server 220a-m to provide supply and/or logistics chain management performance and other information, directly or indirectly, to the supply and/or logistics chain management server 204.

The shipment enterprise server(s) 250 represent(s) the freight enterprises handling air, land or water borne shipments between nodes (e.g., sites) of the supply and/or logistics chain. The freight enterprises can be any entity providing shipping or freight services. Exemplary freight enterprises include railway companies, short and long haul trucking companies, freight company servers (to provide freight tracking information, freight movement projections between two locations, and the like), shipping lines, maritime shipping companies, container shipping companies, ro-ro shipping companies, transoceanic shipping companies, logistics services or courier companies, air freight companies, and the like.

The shipments can be tracked by one or more techniques. The shipment enterprise server 250 can provide position and status updates, such as freight tracking information and freight movement projections between two locations, to the supply and/or logistics chain management system server 204. The shipments can be tracked using an active and/or passive satellite positioning system, such as the Global Positioning System, that includes, in the vehicle, a receiver of position-based signals received from a satellite. A typical shipment tracking system, such as a vehicle tracking system, combines the use of automatic vehicle location in individual vehicles with software that collects the fleet data for a comprehensive picture of vehicle locations. Modern vehicle tracking systems commonly use satellite position information (e.g., including information provided from a satellite positioning system (“SPS”), such as GPS, GPRS, GNSS, GLONASS, IRNASS, etc.) technology for locating the vehicle, but other types of automatic vehicle location technology can also be used. In another technique, terrestrial antenna information (such as triangulation) is used to locate a shipment, whether by air, water, rail or road. The shipment vehicle, whether ship, barge, train, truck or airplane, emits an RF signal at periodic intervals enabling position determination by triangulation based on times of receipt at spatially dislocated antennas. The vehicle can also periodically transmit a GPS location signal to a carrier providing current GPS position. The RTLS system can provide information on how fast the shipment is moving (based on changes in position as a function of time) and estimate when the shipment will arrive at its final or intermediate destination. Another possible source of shipment information is real-time satellite feeds, such as Google™ Earth.

The network accessible information source(s) 224 include any source of information relevant to supply and/or logistics chain performance, including, without limitation, social networks such as Twitter™ Firehose™, news sources and/or aggregators (to provide news on current events that may impact positively or negatively the supply and/or logistics chain performance), weather data sources (e.g., the National Weather Service, national and local news sources, the Weather Channel™, Weather Source™, worldweatheronline.com, and the like), governmental entities (such as courts, law enforcement authorities, geological surveys, disaster relief agencies, and the like to provide legal or regulatory changes or requirements, lawsuits, bankruptcy filings, and the like, and other information), and law enforcement or military authorities.

Such information sources can be monitored applying word cloud techniques to one or more information feeds, which graphically represent word usage frequency. Generally, the more frequent a word or group of words is used the greater the likelihood that the fact or event described by the words or group of words exists. The words or group of words can further be weighted for reliability by the source, with law enforcement and military authorities being given a higher or more reliable weighting than news sources. Other automated techniques can be employed. For example, a web crawler is an Internet bot can systematically browse the World Wide Web, typically for the purpose of Web indexing. Web crawlers can copy all the pages or other information they access for later processing by a search engine that indexes the downloaded pages so that users can search them much more quickly. Human agents can also monitor information sources for event related information.

The various servers and sources are connected by a circuit and/or packet switched wide area network (“WAN”) that covers a broad area (e.g., any telecommunications network that links across metropolitan, regional, or national boundaries) using private and/or public network transports. An exemplary WAN is the Internet.

While the supply and/or logistics chain is described primarily with reference to manufacturing and distribution of a product, it can be applied equally to warranty and/or repair or maintenance services and logistics and procurement operations. The term “supply and/or logistics chain(s)” and variations thereof are intended to encompass these other types of operations.

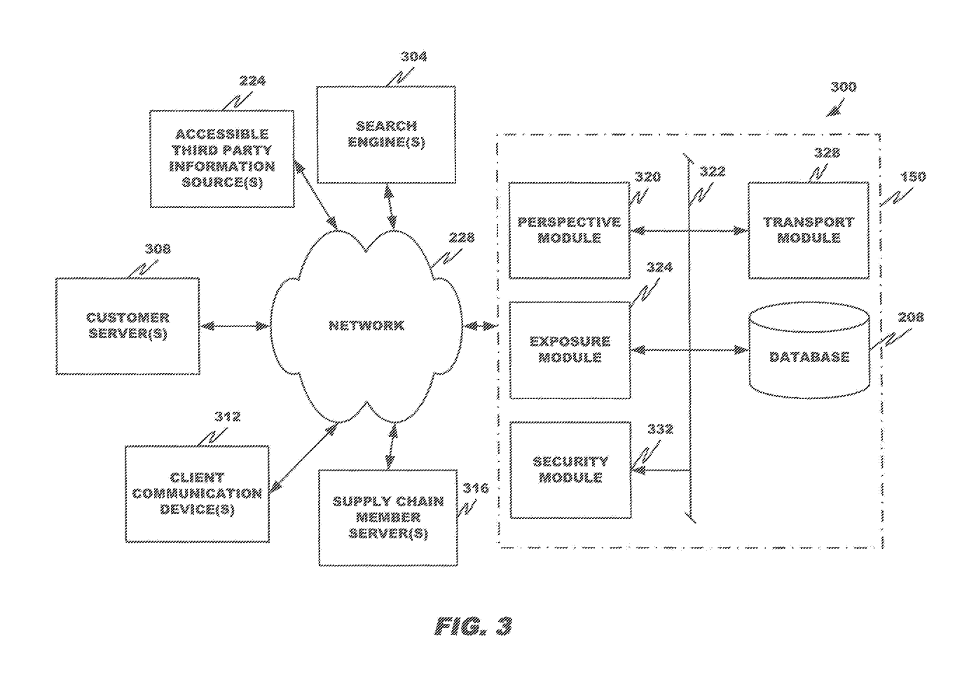

FIG. 3 depicts an example of a supply and/or logistics chain monitoring system 300. The system 300 comprises the supply and/or logistics chain management system 150, search engine(s) 304, accessible third party information source(s) 224, customer server(s) 308 (which, for example, is a server maintained by a brand owner other than an OEM), client communication device(s) 312 (which include any portable or non-portable communication device such as tablet computer, laptop, personal computer, cellular phone, and the like), and supply chain member server(s) 316 (which include tier 1 enterprise server 254, tier 2 enterprise supplier server 212, first, second, . . . nth tier 3 enterprise supplier server 216a-n, and first, second, third, . . . mth tier 4 enterprise supplier server 220a-m), all interconnected by network 228. The supply and/or logistics chain monitoring system 300 can determine, based on past supply and/or logistic chain performance information, a performance rating for a selected object in the supply and/or logistics chain. The performance rating can be based on a scale from lowest performance level to highest performance level. The supply and/or logistics chain management system 150 includes a perspective module 320, an exposure module 324, a transport module 328, a security module 332, and the database 208 connected by a local area network or bus 322.

The Perspective Module 320

The perspective module 320 can monitor the health and operation of a selected supply and/or logistic chain using defined parameters. The user can select one or more KPIs of interest and the module 320 will monitor temporally changes in the values of the KPIs. Examples of KPI metrics include DIFOT (delivery in full and on time), on time shipping/delivery (e.g., on time customer shipment, on-time supplier delivery, on-time arrivals, etc.), LIFR (line item fill rate, perfect or error free measurement, customer order to commit cycle time, order cycle time of finished goods, on time supplier orders, days of supply: finished goods, work in process (e.g., parts or components), or raw materials, inventory: finished goods, work in process (e.g., parts or components), or raw materials (e.g., “RAW/WIP/FG” inventories), perfect order fulfillment, total supply cost, supply and/or logistics chain costs as percentage of sales, total supply and/or logistics chain cost per unit sold, warehousing cost, transport cost per unit, labor productivity rates, delivery performance, fill rate, supplier fill rate, order fulfillment lead times, supply and/or logistics chain response time, production flexibility, cycle time, defects per million opportunities or DPMO, shipping accuracy, % orders with products on back order, order compliance, supplier lead-time variability, units of a selected component, part or product produced today, days of supply of such units, component, part or product yields, phase in and/or out of a unit, last time buy of a type of unit, and the like. When a KPI metric rises above or falls below a selected threshold, a warning or other notification can be sent to the user. The perspective module 320 can obviate the needs to send the user spreadsheets or manually copy data between systems. The perspective module 320 can provide a common source of supply chain and/or logistics information across a selected multi-enterprise supply and/or logistics chain, e.g., from suppliers, to manufacturers, to distributors, and to carriers. When a selected KPI metric exceeds configured thresholds, for example, dashboard alerts can be provided to specified users.

Dashboard displays can provide users with real-time tracking of selected KPI metrics in a selected supply and/or logistics chain. The displays can be user configurable and include a number of different dashboard elements including: gauges (e.g., at-a-glance tracking of high level health indicators), trend lines (with optional thresholds) to view how a selected KPI metric or set of KPI metrics changes over time to get early warning into potential problems, scorecards (with optional breakdowns and thresholds) to track important numerical values or KPI metrics, such as dollars of global inventory, and pie and/or bar charts. The dashboard element can show the KPI metric on an absolute (e.g., numerical) or relative (e.g., percentage) basis.

The Exposure Module 324

The exposure module 324 can identify and respond to risks in a selected supply and/or logistics chain. It can show a user where and by whom each and every component of a selected product is manufactured, supplied, and distributed. The exposure module 324 enables event risk and operations management throughout the supply and/or logistics chain by constantly tracking selected news sources of global events, such as by social networks, news feeds, governmental statements, and the like. Each news source can have an assigned degree of reliability or reliability ranking for use in determining whether or not to notify designated recipients for a selected supply and/or logistics chain of an event potentially impacting the selected supply and/or logistics chain and, if so, provide designated recipients with an indication of the reliability of the event information. The exposure module 324 can receive a live news feed from selected news sources on what is happening in the world that might impact a selected supply and/or logistics chain. The news feed can bridge over to events.

The exposure module 324 can enable a user to identify and respond to event-related risks in a selected supply and/or logistics chain by knowing immediately what sites, parts, and products may be impacted. The exposure module 324 can enable the user to ping part and component suppliers directly to verify impact and kick-start disruption event mitigation. The exposure module 324 can monitor the selected supply and/or logistics chain with substantial real-time 24-hour, seven-day-a-week, and/or 365 days/year “24/7/365” global event feeds. When a disruption event occurs, the exposure module 324 can geo-locate the failure path against plural points in the selected supply and/or logistics chain and assess a likelihood of impact toward the delivery of products to customers, and, when the likelihood and/or severity of impact is sufficiently high, generate and send to a client communication device 312 an auto-notification containing event information.

The exposure module 324 can determine, by applying risk analysis, whether the event is likely to impact the selected supply and/or logistics chain and provide a warning to the user. The degree of impact can be based on one or more of an event associated risk assigned to the respective tile and a relative degree of impact of the event on the corresponding site, part, component, product, shipment, enterprise, selected order, revenue, profit, etc., compared to a degree of impact of the event on another of the corresponding site, part, component, product, shipment, enterprise, selected order, revenue, profit, etc. The impact calculation can be preconfigured and/or configured by or for customer requirements. Ranking the impacted objects against each other can be done to know which impacted object is a more significant impact to a selected supply and/or logistics chain. This “relative” aspect takes this calculation from a generic risk analysis to a risk analysis configured for a particular set of circumstances and/or supply and/or logistics chain.

The exposure module 324 can provide a live view, which is a focused, real-time view of the disruptions and/or other events impacting manufacturers, suppliers, and/or distribution sites in a selected supply and/or logistics chain. When events occur, the exposure module 324 can display an event perimeter ring, or range of disruption, on the live view map with details showing supply and/or logistics chain failure paths and tier 1-4 enterprise interconnections. For example, as shown in FIG. 4 a disruption event, depicted as an earthquake, can be shown on the map display at a location 408 impacted by the event. The range of disruption 412 is assigned to the disruption event indicating a likely spatial range impacted by the event. As will be appreciated, different event types and events for a given event type can have differing assigned spatial ranges of disruption. For example, an earthquake may have a larger spatial range of disruption than a storm, and an 8.0 earthquake on the Richter scale would have a larger spatial range of disruption than a 5.5 earthquake on the Richter scale. A range can be modeled by many techniques, such as by using a shape file. The exposure module 324 can enable the user to drill down by site to view indirect impact of upstream failures or disruptions on products and customers.

The exposure module 324 can enable a user to work through a part or component list for a selected product, starting with single-sourced parts or components for each event that occurs. As the user works through the list, he or she can mark the event severity as none, low, medium, or high, thereby enabling the list to focus on resolving high impact products first.

The exposure module 324 can notify not only the user of an event but also the tier 1 enterprise or tier 2-4 enterprise suppliers (e.g., manufacturers and/or suppliers and/or sites) in the event impact zone. In this manner, each tier 1-4 enterprise or impacted site can proactively indicate whether they are impacted (and, if impacted, a degree of impact severity) or in the clear, thereby enabling the user to focus more quickly and effectively on mitigation.

The Transport Module 328

The transport module 328 can enable a user to manage and substantially optimize a global transportation network. It can show a user real-time information for each and every route and shipment in a selected supply and/or logistics chain, even down to individual route segments, thereby enabling the user to anticipate delays and fix them before they impact customers. The module 328 can provide monthly performance reports that compare costs, service level agreements (“SLAs”), and actual shipping times. The module 328 can provide not only shipment visibility and estimated shipment arrival times but also early warning of delays. It can enable a user take an appropriate action for a late shipment, such as drilling down to identify the root cause and collaborating with the shipper, manufacturer, distributor, assembler, or other supply and/or logistics chain member to resolve the issue or mitigate the impact of the late shipment on the selected supply and/or logistics chain. It can provide the user with a supply and/or logistics chain view showing all of the sites in a selected supply and/or logistics chain and the routes that connect them. The user can easily filter routes by source or destination site. It can enable a user to select a route by allowing the user to view all the ports, depots, or airports and intermediate transfer points along the route and to review and compare alternate routes. In one shipment tracking example, a tracking view provides real-time visibility into the shipments flowing through a selected global supply and/or logistics chain. Every shipment, including those still being processed at a site, is visible on an interactive global map. The user can select (e.g., by clicking, gesture, or other input) on a site to reveal relevant location and shipment details or select a shipment to reveal details on contents, status, and estimated delivery. The transport module 328 can access historical transit times for intermediate segments and warn a user when a shipment will arrive late even if the shipment is still en route. It can help the user to optimize a selected supply and/or logistics chain transportation network by providing historical analysis of carrier performance. It can use monthly reports that compare costs and actual shipping times to contracted SLAs to manage carriers more effectively.

The transport module 328 can use one or more independent sources, in addition to the freight carrier or shipping company, to determine status and/or location of a selected shipment. One independent source is an RTLS system using a combination of satellite position information (such as a satellite positioning system (“SPS”), e.g., GPS and GLONASS) and terrestrial antenna information (such as triangulation) to locate a shipment, whether by air, water, rail or road. The dual use of an SPS and terrestrial antenna information is synergistic. For example, in densely populated, forested, or mountainous areas an SPS can lose accuracy due to signal interference or loss.

The transport module 328 can provide scheduling information, including projected shipment arrival dates for parts, components, and/or products from a first, second, third, or fourth tier enterprise 100, 104, 108, and 112 and required shipment departure dates for parts, components, and/or products. Each of the shipment arrival and departure dates can be linked to a set of data structures describing the shipment, including shipment source and destination, freight carrier, freight tracking information, current shipment status and/or location, shipment contents (by product type and number), date of shipment, and the like). The projected shipment arrival dates can be received from the transport module 328. The shipment departure dates can be determined from the enterprise sourcing the part, component, and/or product.

The supply and/or logistics chain monitoring system 300 can track past performance for a selected object (e.g., a tier 1-4 enterprise and/or enterprise site and/or freight carrier and/or shipping route), such as by comparing the actual part, component, and/or product shipment arrival or departure date against a selected date (received from the carrier, required by contract or order or SLA, and/or projected by the supply and/or logistics chain monitoring system 300), to evaluate performance of the object, identify seasonal trends, and the like. The past performance for an object (e.g., whether tier 1-4 enterprise, tier 1-4 enterprise site, freight carrier, hub, intermediate transfer point, or shipping route) can be used to determine and assign a level of confidence in part, component, and/or product deliveries being received by the selected date. The level of confidence, when low, may provide a basis to order additional part, component, and/or product from a more reliable source. The level of confidence can also be based on past performance of each tier 1-4 enterprise or each different facility of a common tier enterprise.

The estimated or projected delivery date for an order can include an associated probability or likelihood and, optionally, an associated range of arrival dates that the parts, components, and/or products in the order will be timely received by the selected arrival date or within the range of arrival dates. The range of arrival dates can be selected using a standard deviation of arrival times based on current and/or historic performance information and/or other relevant information. For example, a historic reliability or probability of timely receipt at a destination facility from the selected lower tier enterprise supplier site, and optionally associated standard deviation of historic receipt dates for the parts, components, and/or products relative to a target date, can be used to provide the probability and optionally standard deviation of the destination facility receiving a current shipment from the selected lower tier enterprise supplier site.

The Security Module 332

Security over the wide area network 228 is managed by the security module 332 to protect transmitted information. As set forth in co-pending U.S. application Ser. No. 13/935,209, which is hereby incorporated herein by this reference for all that it teaches and for all purposes, the security module 228 routes every data query through a single “Platform Query” entry point that enforces appropriate security constraints. Access to objects and records can be controlled at the user, role, organization, and enterprise level. A user can specify access based on the relationship among multiple enterprises. For example, if companies A and B are two OEMs that outsource manufacturing to a selected company C and if company A wants to share order information with a selected carrier company, company A can share the information even if company B has a different agreement with company C that does not allow the selected carrier company to see company B's orders. The security module 332 can enable the collected information to be maintained in one data location (and common database) without the use of a partitioned database. This can enable the use of a simpler data model that enables ease of constructing relationships between enterprises, provides stability, and provides scalability. Each data row of the model can have a different schema. The data model can also enable sharing of information across and among different supply and/or logistics chains.

The security module 332 can further provide cloud security, such as secure client connectivity with extended validation (“EV”) certificates, OpenID challenge/response client authentication, user-specific authorization tokens, database/application separation, support for secured socket layer (“SSL”) encryption of API calls, separation of credential storage with no credential access from interface zones, and mechanisms to prevent data spoofing and query injection.

The Database 208 and Database Management System

The database contains supply and/or logistics chain performance information collected from tier 1, 2, 3, and/or 4 enterprises and freight companies in the supply and/or logistics chain and from accessible information source(s) 224. A database management function can store, update and otherwise manage the data in the database 208 in accordance with a selected data model. The data structures are typically associated with one or more enterprises (e.g., material supplier, part/component manufacturer, product assembler, freight or shipping company, distributor, brand owner, wholesaler, and/or retailer) in the supply and/or logistics chain. Transactional documents, such as purchase orders, material safety data sheets, and bills of material, and agreements, such as supply and/or manufacturing agreements, or RMAs, and SLA's, contain references to all owners down the organization level, have corresponding role types and functions specified (e.g., only a buyerRole can change requestQuantity field), and include preferences and settings referenced to an appropriate level (e.g., enterprise (or the part of the enterprise involved in the supply and/or logistics chain transaction), user, etc.).

The database 208 can include, for each selected enterprise in the supply and/or logistics chain (e.g., each tier 1, 2, 3 or 4 enterprise), name, geographical location of corresponding sites, geopolitical location of corresponding sites, material, part, component, and/or product type and/or identity supplied by the enterprise and by each corresponding site, current spot market and/or contractual sales price of the material, part, component, and/or product type supplied by the enterprise, respective supply and/or logistics chain performance metrics of the enterprise and/or each site of the enterprise, material, part, component, and/or product supply and/or purchase commitment with another enterprise in the supply and/or logistics chain, specifications and requirements for material(s), parts), component(s), and/or product(s) supplied and/or purchased by the enterprise, bills of materials for materials, parts, components, and/or products, material, part, component, and/or product quantity and shipment dates and expected arrival dates at the next enterprise in the supply and/or logistics chain, order cycle and/or turnaround times, shipment and/or order volume, total number of shipments, number of on time shipments, number of late shipments, order mismatch count, repair details, and an association of the selected enterprise with one or more other enterprise(s) in the supply and/or logistics chain, such as by a contractual or other supply relationship.

Relevant data types for the event can include not only the event category, type, subtype, and severity but also objects impacted by the event, such as number of materials and/or parts and/or components and/or products impacted, number of downstream parts and/or components and/or products impacted (such as the parts and/or products supplied to the tier 1 enterprise 104), potential financial impact on all or part of the supply and/or logistics chain, and a number of supply and/or logistics chain sites affected.

While any data model and database management system can be employed, the database 208 management system typically uses a NoSQL database. As will be appreciated, a NoSQL database provides a mechanism for storage and retrieval of data that is modeled in means other than the tabular relations used in relational databases.

The Microprocessor Executable Components of the Exposure Module 324

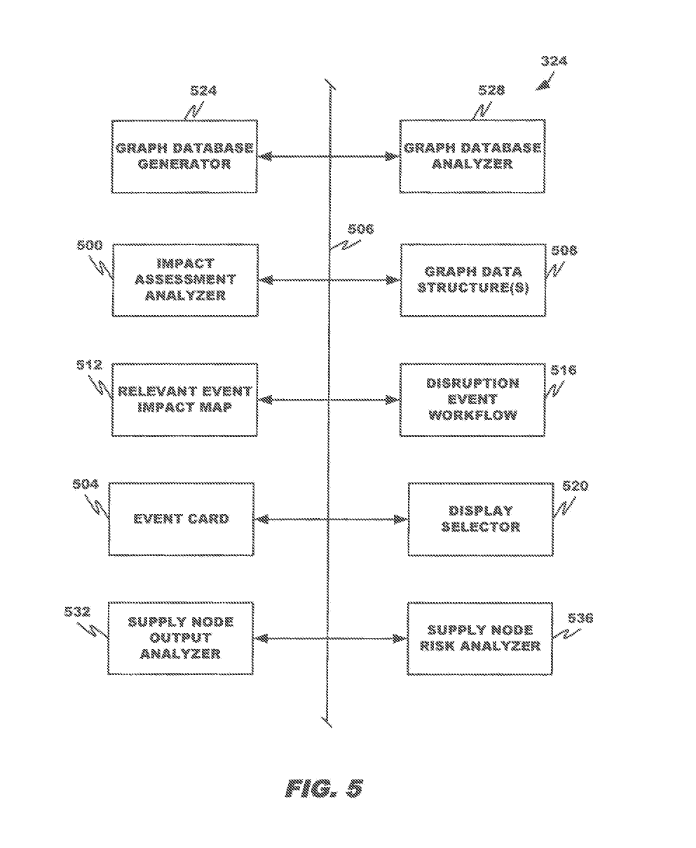

With reference to FIG. 5, the exposure module 324 includes an impact assessment analyzer 500 that, for an event, determines a degree of impact of the event on a selected supply and/or logistics chain. The analyzer 500 creates, for the event, an event card 504, which is a set of data structures containing the event related information associated with event. The impact assessment analyzer 500, based on a traversal of a set of graph data structures 508 defining the selected supply and/or logistics chain by a graph database analyzer 528, evaluates the impact of the event on the selected supply and/or logistics chain and determines a concomitant risk associated with the event and outputs a relative event impact map 512 visually depicting the impact and risk, thereby enabling a user to determine whether the workflow associated with the event should be escalated. The set of graph data structures 508 can be generated manually or by a graph database generator 524. When the event is escalated to a disruption, the exposure module 324 instantiates a disruption work flow 516 to mitigate the impact of the event on the supply and/or logistics chain. A display selector 520 controls the display and the display configuration and selects the information displayed to the user. A content analyzer may locates published content (e.g., news items), such as via a network accessible information source(s) 224, creates a content card corresponding to the selected content or group of related content items, analyzes the impact (if any) subject matter of the selected content item(s) corresponding to the content card on a selected supply and/or logistic(s) chain, and publishes the content item(s) and/or a summary thereof, with an indication of any potential impact of the subject matter of the content item(s) on the selected supply and/or logistic(s) chain, to user interfaces of client communication device(s) 312 associated with the selected supply and/or logistic(s) chain. A publication module publishes information output by any of the forgoing components to one or more selected user interfaces of client communication device(s) 312 associated with a selected supply and/or logistic(s) chain. In some embodiments, the one or more of the components included in the exposure module 324 may be connected by a local area network or bus 506.

The Event Relative Impact Map 512

The relative event impact map or “RIM” 512 shows the supply and/or logistics chain risk analysis of an event or issue's impact severity on a selected object relative to a set of objects (e.g., part, site, purchase order, transport lane, etc.). These objects are represented as tasks to be completed to resolve the issue. The RIM 512 evaluates, substantially in real time, existing issues and, as tasks are resolved, recalculates by the impact assessment analyzer 500, the relative importance of each remaining object (e.g., if an event is impacting 15 sites but 5 have been mitigated, the RIM 512 will be recalculated to evaluate the relative impact of the remaining 10 sites). The RIM 512 can be accessed through event/issue card detail pages. The map feature can enable a user to quickly diagnose and prioritize the sites most impacted by an event and to take steps to respond to a supply and/or logistics chain disruption event and/or mitigate the effects of the disruption event on the supply and/or logistics chain, thereby conserving computational resources and bandwidth and enabling less capable communication devices, such as tablet computers and cellular phones, to provide the RIM 512 to the user.

The Supply Node Output Analyzer 532

The supply node output analyzer 532 may be configured to receive information from one or more nodes in a network. Among other things, the supply node output analyzer 532 may be configured to determine the number of edges, nodes, and relationships between the edges and nodes in a network. In analyzing the nodes of a network, the supply node output analyzer 532 may create a network node map. Additionally or alternatively, the supply node output analyzer 532 may determine the number of incoming and/or outgoing edges at each node in the network. This number may be based on a particular output of each node in the network. In some embodiments, the supply node output analyzer 532 can determine geographical location information associated with each node or group of nodes in a network. This geographical location information may be used to generate a node locality including two or more nodes in a similar, if not identical, region. In one embodiment, the geographical location information may include distances between nodes in a network. Additionally or alternatively, the supply node output analyzer 532 may be configured to determine network, node, and/or edge statistics, performance, and the like. As can be appreciated, the supply node output analyzer 532 may be used to determine similar information as described herein for the edges and/or receiving nodes within the network.

The Supply Node Risk Analyzer 536

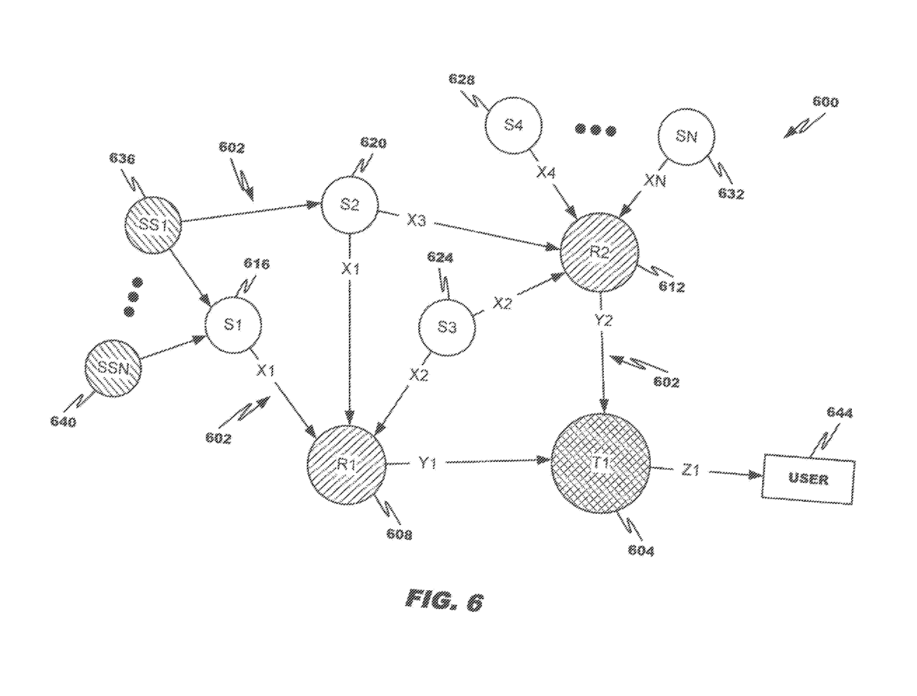

Among other things, the supply node risk analyzer 536 may be configured to communicate with the supply node output analyzer 532. In some embodiments, the supply node risk analyzer 536 is configured to evaluate information provided by the supply node output analyzer 532 in determining a risk and/or a rank of at least one node, edge, and/or output from a node within a network. The supply node risk analyzer 536 can interpret network information, demand, profitability, historical performance, and other factors in determining the risk and/or rank. The operation of the supply node output analyzer 532 and the supply node risk analyzer 536 is discussed in conjunction with FIGS. 6-12.

FIG. 6 shows a network diagram 600 in accordance with embodiments of the present disclosure. In particular, the network diagram includes a number of nodes 604-640 having a relationship in a network, the relationship at least partially defined by one or more edges 602. Each node 604-640 may be configured to provide an output to one or more other nodes in the network. For instance, source supply node 1 (SS1) 636 may provide an output to both object supply node 1 (S1) 616 and object supply node 2 (S2) 620. Continuing this example, S1 616 may be configured to provide first output X1 to receiving node 1 (R1) 608. In one case, S2 620 may also be configured to provide the first output X1 to R1. In some embodiments, particular nodes 608, 612 may be configured to provide an output Z1 to a user 644.

In some embodiments, the nodes 604-640 may correspond to sites, products, facilities, destinations, enterprises, waypoints, and/or other part of a supply and/or logistics chain. Similarly, the network diagram 600 may correspond to a graphical representation of a supply and/or logistics chain management system 150. For example, SS1 636 may correspond to a material supply site, such as a tier 4 enterprise supplier 112 (e.g., supplying raw materials, parts, components, etc.), that provides a supply to one or more tier 3 enterprise suppliers 108 (e.g., S1 616 and S2 620, etc.). In some embodiments, S1 616 may provide an output X1 to R1 608, while S2 620 may provide an output X1 to R1 608 and an output X3 to R2 612, where outputs X1 and X3 may be different and can correspond to parts and/or devices. Receiving nodes 608, 612 may correspond to tier 2 suppliers 104 (e.g., integrating the parts and/or devices received from the object supply nodes (e.g., S1-SN 616-632, etc.) into products. In some embodiments, the receiving nodes 608, 612 may provide product outputs Y1 and Y2, respectively to a tier 1 enterprise (T1) node 604. The T1 node 604 may provide one or more brands Z1 to at least one user 644 (e.g., an end user, a retailer, a wholesaler, a point of sale, an OEM, etc.).

Although examples of the present disclosure describe specific tier levels for the nodes 604-640 shown in the network diagram 600, it is an aspect of the present disclosure that any node 604-640 may correspond to any tier level depending on the configuration of the network. In addition, while a limited number of nodes 604-640 are shown in the network diagram 600, it should be appreciated that this limited number of nodes 604-640 is shown for the sake of clarity and embodiments of the present disclosure should not be so limited. For instance, while only three object supply nodes are shown as providing, or capable of providing, an output to R1 608 in the network diagram 600, many other nodes may provide a supply to R1 608. The same holds true for the other nodes in the network diagram 600.

By way of example, the T1 node 604 may be a vehicle manufacturer receiving a first model vehicle (e.g., shown as output Y1) from R1 608 and a second model of vehicle (e.g., shown as output Y2) from R2 612. In turn, the first vehicle may require integration of various components or subassemblies provided by suppliers represented by nodes S1-SN 616-632. For instance, S1 616 may provide tires, S3 may supply engines, and other nodes (not shown) may provide metal, frames, wiring, switches, processors, conduit, glass, windows, lighting, electronics, textiles, and so on.

As shown in the network diagram, S2 620 may be an alternate supply node for a particular object (e.g., output X1) provided by S1 616, or vice versa. Having alternate suppliers for a number of components can provide a robust supply and/or logistics chain. In contrast, having a sole source supplier for a particular output required by the network may risk failure of the entire network, or at least a portion thereof. For example, S3 624 is the sole source supplier of output X2. Continuing the example above, the output X2 provided by S3 624 may correspond to the engine of a vehicle. Moreover, because both R1 608 and R2 612 require the output from the sole source supplier, i.e., S3 624, there is a risk that a failure at S3 624 can cause a failure of the T1 node 604 to provide an output Z1 (that includes output Y1 and/or Y2) to user 644. In this example, S3 624 may be identified as a possible single point of failure (SPOF).

In some embodiments, the SPOF may not only be associated with a sole source supplier in a network. For instance, both S1 616 and S2 620 are capable of providing the same output (e.g., output X1) to R1 608. However, the output X1 may be identified as a sole source output when a single event, series of related events, and/or separate events may cause both S1 616 and S2 620 to fail at substantially the same time. By way of example, S1 616 and S2 620 may be located in the same geographical region. The geographical region may be prone to earthquakes, floods, or some other extreme environmental condition, etc. Because both object supply nodes 616, 620 providing the unique output X1 are in the same region, the output X1 may be identified as an SPOF. A similar, if not identical, analysis may be performed for the edges 602 of the network. Among other things, this analysis whether applied to nodes, edges, and/or outputs, may consider transportation paths, shipping points, travel lanes, weather, geography, geopolitical conditions, and/or other factors in determining any SPOFs or parts of the network having some identifiable or foreseeable risk.

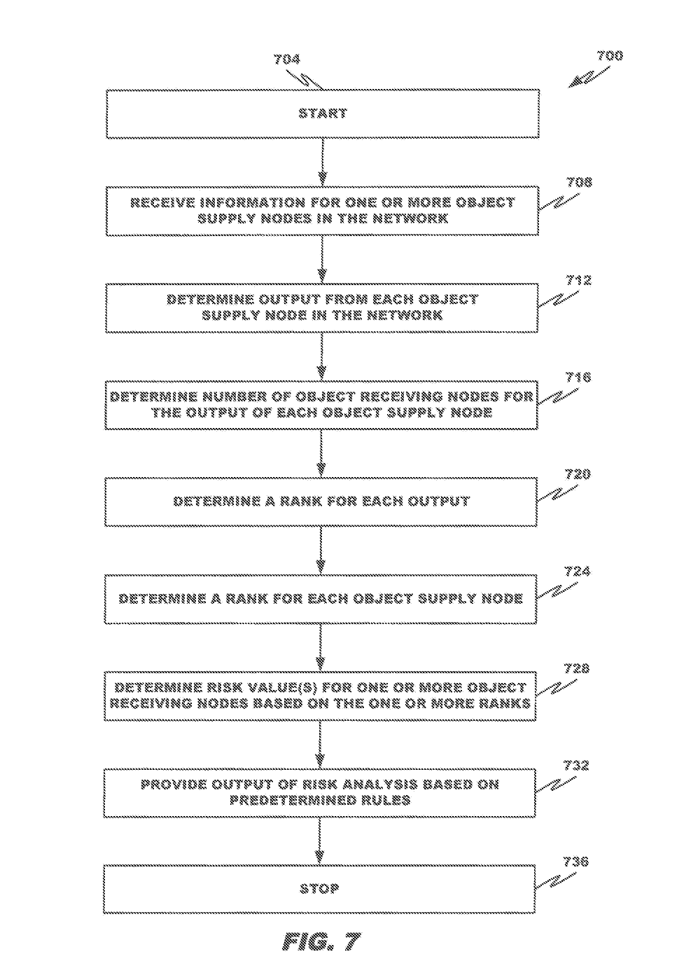

An embodiment of a method 700 to analyze and rank parts of a network is shown in FIG. 7. A general order for the steps of the method 700 is shown in FIG. 7. Generally, the method 700 starts with a start operation 704 and ends with an end operation 736. The method 700 can include more or fewer steps or can arrange the order of the steps differently than those shown in FIG. 7. The method 700 can be executed as a set of computer-executable instructions executed by a computer system and encoded or stored on a computer readable medium. Hereinafter, the method 700 shall be explained with reference to the systems, components, modules, software, data structures, user interfaces, etc. described in conjunction with FIGS. 1-6.

The method 700 begins at step 704 and proceeds by receiving information for one or more of the object supply nodes 604-640 in the network (step 708). In one embodiment, this information may be provided by at least one object supply node 604-640 providing the information to a supply and/or logistics chain monitoring system 300. In some embodiments, the information may be retrieved from the one or more object supply nodes 604-640 in response to a request initiated by at least one component of the supply and/or logistics chain monitoring system 300. Additionally or alternatively, the information for the one or more object supply nodes 604-640 may be compiled by a supply node output analyzer 532 from at least one of a network map, a graph structure, a graph database, a network diagram 600, etc., and/or some other source.

The information for the one or more object supply nodes 604-640 can include, but is in no way limited to, an identification of one or more output provided by each node, a location in a network diagram 600, a position in a graph structure, a dependency of any other nodes on the output of the node, a dependency of any other nodes and/or edges on an edge of the node, edge connections to and/or from the node, site location of the node, output cost associated with the node, output delivery timing associated with the node, historical information associated with the node, profitability associated with the node, quality of the output provided by the node, etc., and/or combinations thereof. In one example, a particular node (e.g., S1 616) may represent a site that produces a part (e.g., output X1) for assembly or integration by another node, site, or facility (e.g., R1 608).

The method 700 may continue by determining the output from each object supply node in the network (step 712). In some embodiments, the output may include an object, information about an object, and/or a capability for providing the object from the node. The output of a node may be generated based on input received from one or more other nodes. Generating an output at a node may include adding an object or work to the input received from the one or more other nodes.

Next, the method 700 may proceed by determining a number of object receiving nodes for the output of each object supply node (step 716). Each output may be associated with a destination or receiving node. For instance, a particular product may be represented by receiving node R1 608. In this example, the product may include a number of parts. Each part can correspond to an output from a node. Additionally or alternatively, each product may include a list of parts or components that are included in the product. This list may be referred to herein as a bill of materials (BOM). In some cases, the BOM can include one or more of part numbers, descriptions, quantities, source identifications (e.g., object supply nodes), costs, profitability, assemblies where used, other part information, and/or other information. The various components of the supply and/or logistics chain monitoring system 300 may use information obtained from the BOM to analyze risk, generate a rank, and/or otherwise classify parts of a network (e.g., the nodes, edges, and/or outputs of nodes, etc.).

The method 700 continues by determining a rank for each output in the network (step 720). The rank may correspond to a relationship of the output to at least one other output and/or node in the network. In some embodiments, the rank may be based on how interconnected the output is to one or more nodes in the network. In the vehicle example previously described, a high rank output may be equivalent to a part that is used in more than one product (e.g., having a great number of interconnections, etc.), while a low rank output may be equivalent to a part that is used in only one product in a network.

In one embodiment, the method 700 may optionally proceed by determining a rank for each node in the network (step 724). The node rank may correspond to a relationship of the node to at least one other node in the network. In some embodiments, the node rank may be based on how interconnected the node is to one or more other nodes in the network. For example, a high rank node may be equivalent to a node that provides a number of outputs used in one or more products (e.g., the node may have a great number of interconnections on a nodal or output basis, etc.). A low rank node may be equivalent to a node that provides either a single output to a particular node or a number of outputs to only a single node in a network.

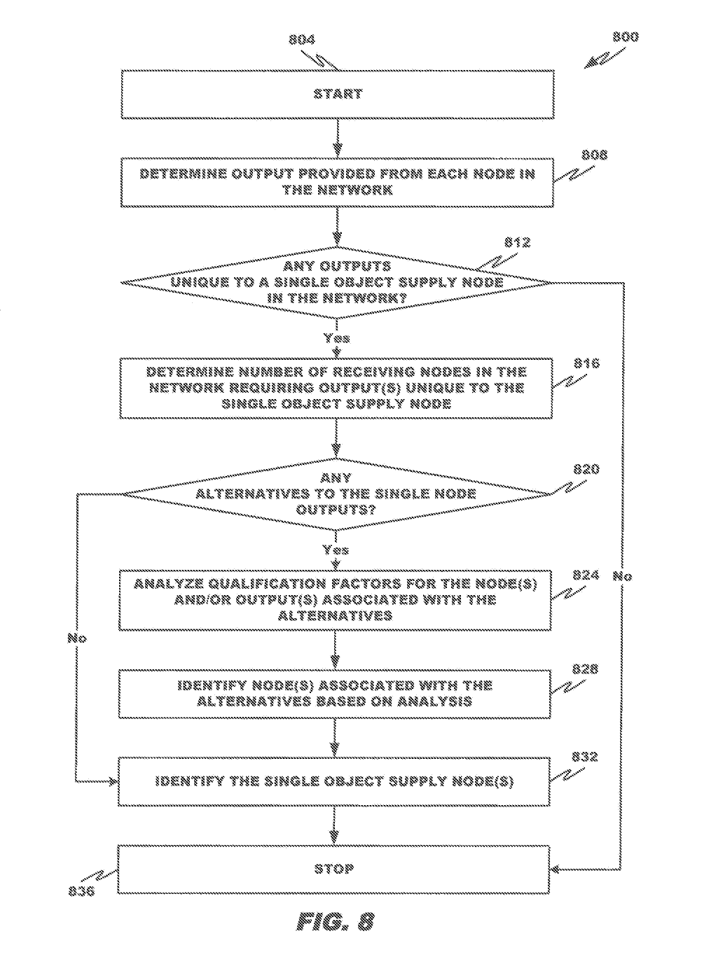

In any event, the method 700 proceeds by determining a risk value for the one or more object receiving nodes 608, 612 based at least partially on the rank of the output and/or object supply nodes 616-632. For example, the risk value may be based on an availability of specific outputs, an importance of the output to the object receiving nodes 608, 612, the network, other products, and/or other outputs, etc. In some embodiments, the risk may be determined based at least partially on the scarcity and/or complexity of outputs required by a particular node or nodes of a network. Additionally or alternatively, the risk may be determined based at least partially on other factors associated with the receiving node 608, 612, object supply nodes 616-632, edges 602, and/or outputs of the nodes. These other factors may include, but are not limited to, geography, weather, EECs, season, frequency of historical issues, geopolitical factors, scarcity of supply, market trends, Internet trends, social media trends, etc., and/or combinations thereof. Additional or alternative embodiments for determining risk of one or more parts of a network are discussed in conjunction with FIGS. 8-12.

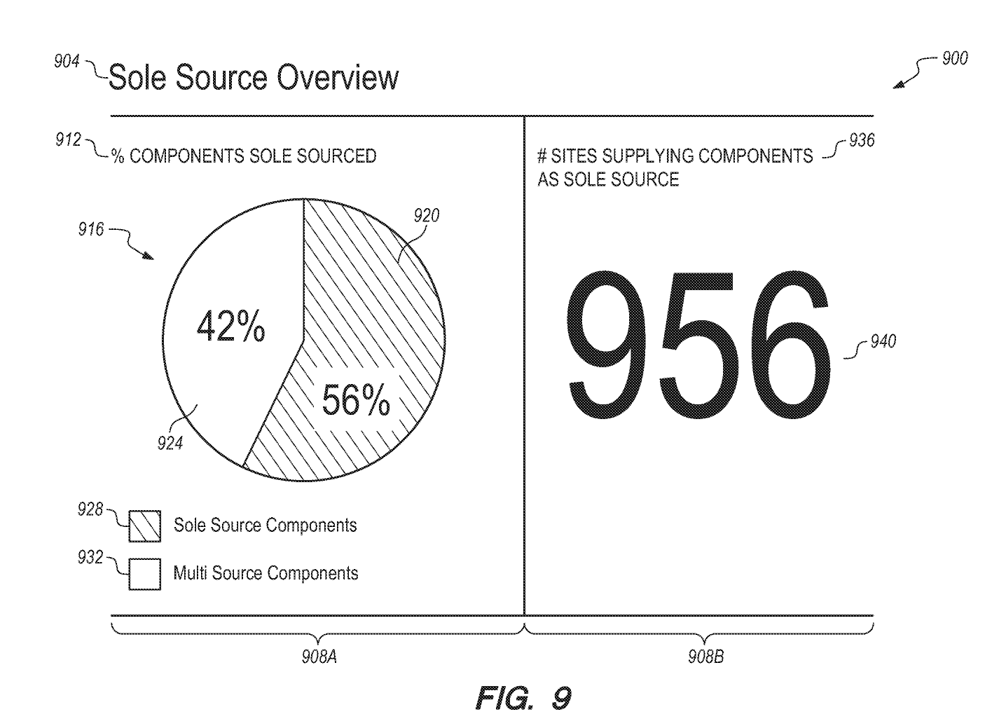

Once the risk is determined, the method 700 may proceed by providing an output of the risk associated with the network based on predetermined rules (step 732). The risk output may include presenting a graphical representation of the risk associated with one or more nodes of the network to a user 644 (e.g., via a display or output presented to another device). Examples of a graphical representation may include, but are not limited to, providing an ordered list of nodes having specific risks associated therewith, a chart of nodes having some risk, a comparative analysis of high risk nodes to low risk nodes, a temperature map showing various colors representing varying degrees of risk, a network diagram 600 showing risk associated with each node, a geographical map showing risks associated with specific node locations, a card of one or more high risk nodes only, an alert or notification of nodes having risk levels above a predefined threshold, etc., and/or combinations thereof. At least some graphical representations are described in conjunction with FIGS. 9-12. In any event, the method 700 may end at step 736.

An embodiment of a method 800 to identify nodal weaknesses in a network is shown in FIG. 8. A general order for the steps of the method 800 is shown in FIG. 8. Generally, the method 800 starts with a start operation 804 and ends with an end operation 836. The method 800 can include more or fewer steps or can arrange the order of the steps differently than those shown in FIG. 8. The method 800 can be executed as a set of computer-executable instructions executed by a computer system and encoded or stored on a computer readable medium. Hereinafter, the method 800 shall be explained with reference to the systems, components, modules, software, data structures, user interfaces, etc. described in conjunction with FIGS. 1-7.

The method 800 begins at step 804 and proceeds by determining the output provided by each node in the network (step 808). Determining the output in step 808 may be similar, if not identical, to determining the output of each object supply node described in conjunction with step 712 of FIG. 7, or vice versa. In some embodiments, the output of each node in the network may be determined based on information stored (e.g., in a non-transitory computer readable medium, etc.) in at least one of a BOM, a list, a database, a graph database, graph data structure, and/or other data structure. The computer readable medium may be stored locally at a node, centrally at a memory accessible via a supply and/or logistics chain management system server 204 (e.g., database 208, etc.), and/or across a communications network 228. In one embodiment, the output of a node may be determined by receiving information provided by the node. For example, the node may respond to a query for information about the output of the node. The query may be sent via a supply and/or logistics chain management system server 204, an enterprise server 212, 216a-n, 220a-m, 250, 254, a customer server 308, a client communication device 312, a supply chain member server 316, and/or some other server. In some cases, the query may be initiated by a user operating a computing device.

In some embodiments, the query may be sent automatically in response to detecting at least one other condition and/or factor. For instance, an EEC may be detected in a particular region associated with at least one site of the network. In response to detecting the EEC, a server may generate and send a query to one or more nodes in the network for information. This information may include a request for information about an output of the one or more nodes in the network. Other factors and/or conditions may include geographic events, weather events, EECs, seasonal timing, historical events associated with a network or parts thereof, geopolitical events, scarcity of supply events, market trends, Internet trends, social media trends, etc., and/or combinations thereof.

Next, the method 800 proceeds by determining whether any of the outputs determined are unique to a single object supply node in the network (step 812). In one embodiment, a unique output may be an output that is only provided by a single object supply node in the network. The unique output may correspond an output of a node in a network that is determined at a particular time. In some embodiments, the unique output may correspond a type of output that is only available from a particular node, geographical region, supplier, site, etc. One example of a unique output may be a rare earth metal, or some other part, that is unique to, or found in abundance in, a particular geographical area. Another example of a unique output may be a part created by an output supply node using a complex and/or proprietary process (e.g., Gorilla® Glass, etc.). In the event there are no unique outputs in the network, the method 800 may end at step 836.

In the event that an output is determined to be unique to a single object supply node in the network, the method 800 may continue by determining a number of receiving nodes in the network that require the unique output provided by the single object supply node (step 816). For example, the receiving nodes 608, 612 may correspond to a manufacturing or integration facility that uses the unique parts and/or outputs to provide a subassembly or assembly of components (e.g., a product, a portion of a product, etc.). In one embodiment, the receiving nodes 608, 612 may represent products in an enterprise. For instance, R1 608 may be a particular product (e.g., a model of vehicle, a smart phone, a computer, etc.) that comprises a number of outputs from one or more object supply nodes. In some embodiments, a unique output may be used in many products of a supply chain. As can be appreciated, any failure of the object supply node providing this unique output would cause a failure of many of the products in the supply chain.

Next, at step 820, the method 800 continues by determining whether there are any alternatives to the single node outputs (e.g., the unique outputs, etc.). Alternatives may include one or more other nodes within or outside of a network that are capable of providing the unique output. Additionally or alternatively, the alternatives may include an alternative output that can be substituted for the unique output. This substitute output may be provided by the one or more other nodes. In some embodiments, the alternatives may be determined by referring to stored data, querying the capabilities of one or more nodes (e.g., whether inside or outside of a network, etc.), and/or based on information provided by the one or more nodes. For example, a product at R1 608 may require a specific type of 6.0-mm inside diameter washer provided by an object supply node (e.g., S3 624, etc.) for a product manufactured at R1 608. Continuing this example, another node (e.g., S2 620, etc.) may provide a 0.25-inch inside diameter washer. In some embodiments, at least one component of the supply and/or logistics chain monitoring system 300 may determine that the imperial washer provided by S2 620 is an acceptable alternative to the metric washer provided by S3 624. Whether an output qualifies as an acceptable alternative may be based at least partially on rules stored in memory. In this example, the unique output of S3 624 has at least one alternative object supply node, namely S2 620.

The method 800 may proceed by analyzing the alternative object supply nodes and/or the alternative output using qualification factors (step 824). Qualification factors used in analyzing and/or assessing a risk associated with alternatives can include, but are in no way limited to, profit of the output, quality of the output, throughput of the output, bandwidth of availability, scarcity of the output, complexity of the output, lead time to receive the output, demand on the output, and/or other factors associated with the output provided by the node. The analysis may include comparing, automatically and via a processor, the qualification factors to the same factors associated with a single object supply node.

Next, the method 800 continues by identifying the nodes associated with the alternatives based on the analysis (step 828). The identification may include a node location, name, output, rating, rank, risk, one or more qualification factors, one or more comparison factors (e.g., comparing the alternative output to the unique output provided by the single object supply node, etc.). For instance, in the previous example, an imperial part is determined to be an alternative to a metric part (i.e., the washer). While the imperial part may be satisfactory for use in the product, the cost associated with the alternative may not be acceptable as a permanent alternative output. This information may be included in the identification.

The method 800 proceeds by identifying the single object supply node or nodes (step 832). In some embodiments, the identification may include highlighting the single object supply nodes as a SPOF or risk to network. The identification of single object supply nodes may correspond to any of the presentations disclosed herein. For example, FIGS. 9-12 show various screen shots and presentations identifying single object supply nodes in a network. Single object supply nodes or SPOFs may represent a weakness within the network that can cause a collapse of at least a portion of the network in the event of a failure at one or more of the SPOFs. The more single object supply nodes or SPOFs in a network, the greater the risk of failure of the network. The kill shot analysis provided by the supply node risk analyzer 536 and/or other components of the supply and/or logistics chain monitoring system 300, can determine the areas of greatest risk in a network. Among other things, the kill shot analysis considers SPOFs, alternatives, multiple-source object supply nodes, and/or the like in determining the risk of a supply and/or logistics chain. The method 800 ends at step 836.

FIG. 9 depicts a screen shot 900 output by the supply node risk analyzer 536 based on input from the supply node output analyzer 532. The screen shot 900 can appear, for example, on a client communication device 312 and may include a title 904, at least one analysis header 912, 936, a graph 916, a legend 928, 932, and analysis data 920, 924, 940. In some embodiments, the data 920, 924, 940 may be presented in a first area 908A and/or a second area 908B of a presentation view.

The screen shot 900 shows a percentage of components that are sole-sourced 920, a percentage of components that have multiple sources 924, and a number of sites that are supplying the sole-sourced components 940. As shown in the screen shot 900, 56% of the components used in the example are sole-sourced. In other words, 56% of the components are provided by a single object supply node. The screen shot 900 also shows that 956 sites (e.g., object supply nodes, etc.) are supplying these sole-sourced components. In some embodiments, the screen shot 900 can provide a summary view of the risk and/or SPOFs associated with a supply and/or logistics chain. Among other things, this view can provide insight to the structure of the supply and/or logistics chain and even bring attention to possible areas of concern before any issues arise.

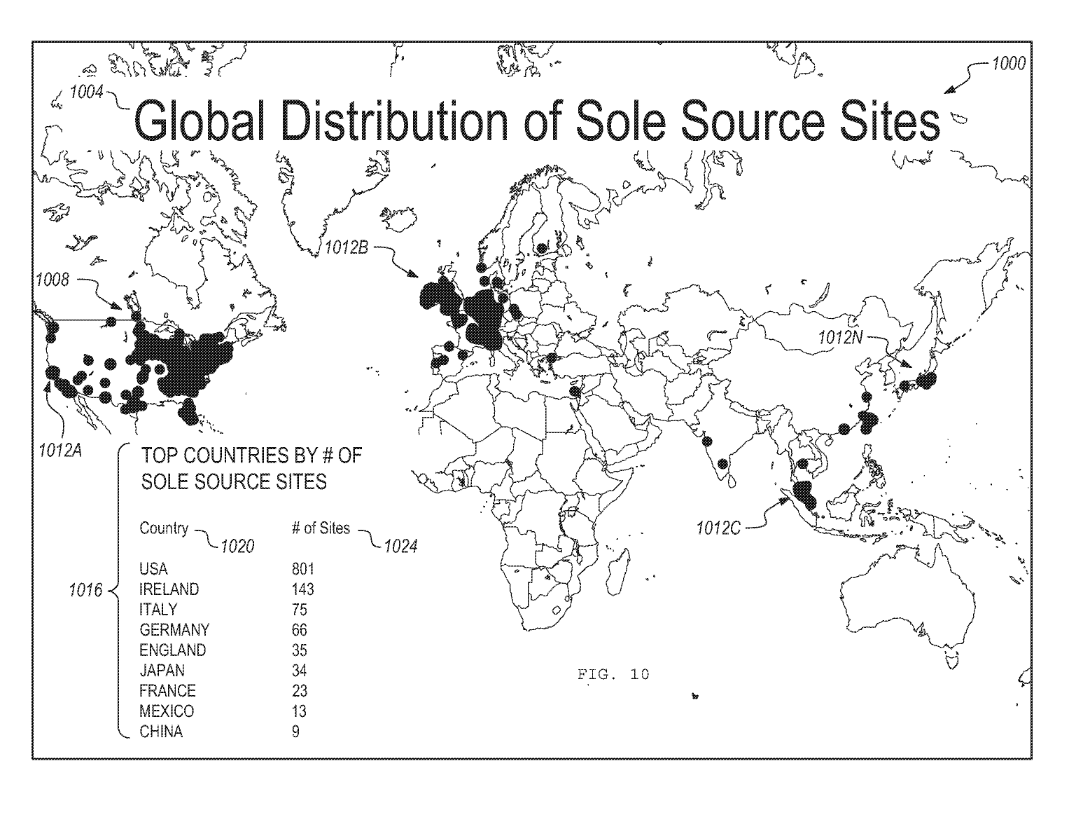

Referring now to FIG. 10, a screen shot 1000 output by the supply node risk analyzer 536 based on input from the supply node output analyzer 532 is depicted. The screen shot 1000 can appear, for example, on a client communication device 312. The screen shot 1000 includes a map 1008 showing the location of sole-source supply sites 1012A-N in a supply and/or logistics chain. The sole-source supply sites 1012A-N may correspond to the single object supply nodes as described herein. In some embodiments, the map 1008 may be configured as a geographical map showing the physical location of the sole-source supply sites 1012A-N in one or more geographical locations on the map 1008. Each sole-source supply site 1012A-N may be represented by a pin, identifier, color, shape, etc., and/or combinations thereof on the map 1008.

In some embodiments, multiple sole-source supply sites 1012A-N may share a geographical location or region on the map 1008. When multiple sole-source supply sites 1012A-N are in a shared geographical region, the size of the identifier may include a mark, size, color, and/or shape to indicate that more than one sole-source supply site 1012A-N can be found in the region. For example, the screen shot 1000 can show multiple sole-source supply sites 1012A-N in a particular shared region as having a varying color representing the number of sites in the region. In this example, the more sites in a given region the darker the color of the identifier. In another example, the identifier may be associated with a color temperature. Using a color temperature, the number of sites in a region can be represented by a specific color. The hotter the color temperature (e.g., red), the greater the number of shared sole-source sites in an area (e.g., a site cluster, etc.). Cooler color temperatures (e.g., blue) can represent fewer, if any, shared sole-source sites in an area or region. In some embodiments, a user may use view controls (e.g., pan, zoom, rotate, etc.) to focus on a particular geographic region that is presented to the device 312. This focus may further illustrate a precise location of each site in a site cluster. The view controls may be configured to automatically show a geographic region based on one or more rules.

The title 1004 of the screen shot 1000 indicates the global distribution of sole-source sites in a supply and/or logistics chain are shown. The screen shot 1000 includes a ranked list 1016 providing the countries having the highest number of sole-source sites listed first. In one embodiment, each entry (e.g., country, etc.) in the countries column 1020 and/or each entry (e.g., number of the sole-sourced sites, etc.) in the number of sites column 1024 may include a link that, when selected, provides a focus view on the map 1008 of the country associated with the number of sole-sourced sites. In some embodiments, selecting the link may provide additional information regarding one or more of the sole-sourced sites in that country or countries.

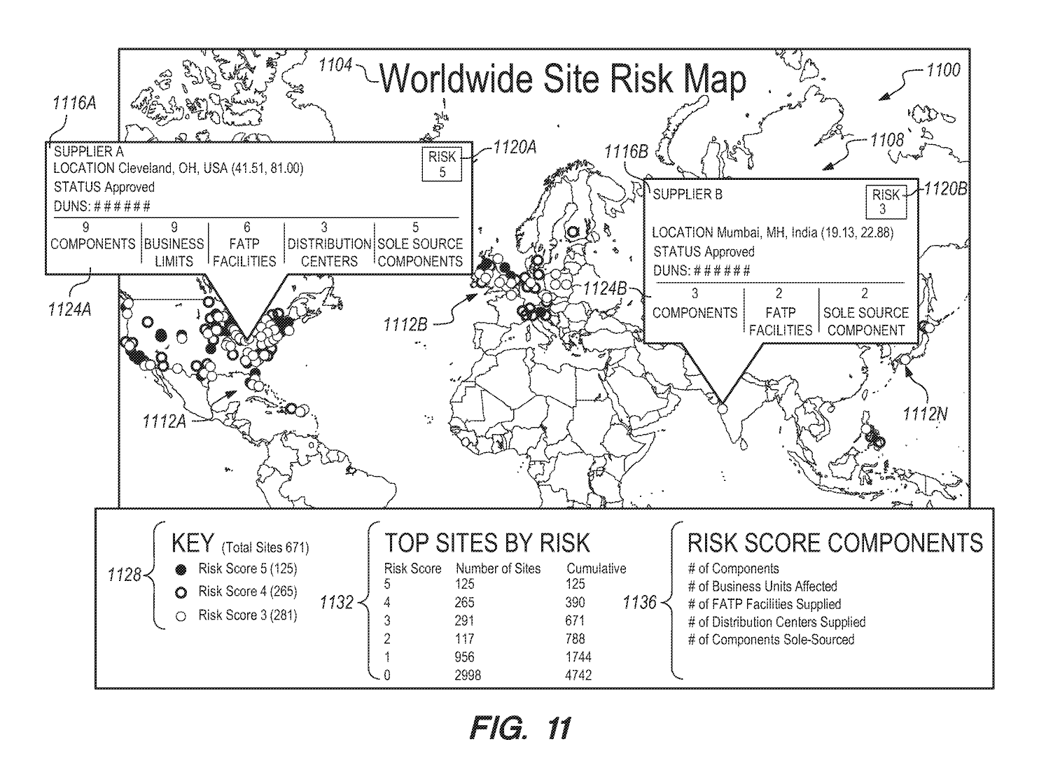

FIG. 11 depicts a screen shot 1100 output by the supply node risk analyzer 536 based on input from the supply node output analyzer 532. The screen shot 1100 shows the worldwide site risk map 1104 associated with a supply and/or logistics chain. As provided herein, the risk may correspond to a risk of one or more of a node, edge, and/or output of a node. For instance, the risk can relate to a determined risk for the entire network, supply and/or logistics chain, a particular product in the supply and/or logistics chain, etc., and/or combinations thereof.

As shown in FIG. 11, a risk identification window 1116A associated with a site from a first geographical region 1112A displayed on a map 1108 is presented. The risk identification window 1116A may identify the supplier name associated with the site (e.g., Supplier A), provide location information and/or other site/output information, a risk value 1120A, and dependency information 1124A. Similar to the other screen shots 900, 1000, the screen shot 1100 may appear, for example, on a client communication device 312. The risk value may be generated based on the number of factors associated with the node that qualify as risk factors. The greater the number of risk factors associated with a node, the greater the risk value associated with that node, and vice versa. In some embodiments, the dependency information 1124A may include a number of components provided by the site, business units related to the site, site assembly and/or testing information, distribution centers associated with the site, a number of sole source components provided by the site, and/or the like.

In the risk identification window 1116A, “Supplier A” is shown located in Cleveland, Ohio, USA and having a risk value 1120A of “5.” The supplier provides 9 components, is associated with 9 business units, includes 6 assembly facilities, 3 distribution centers, and provides 5 sole source components. Among other things, this information can provide a summary view of the risk associated with Supplier A. A similar risk identification window 1116B is shown for Supplier B in a second geographical region 1112N of the screen shot 1100.

In some embodiments, the worldwide site risk map 1104 can include a key 1128 indicating meaning or portions of the map 1104, a ranked list of sites by risk 1132, a risk score factors or components section 1136, and/or more. The ranked risk list 1132 may provide a number of sites, the names of the sites, other information associated with the sites, etc., having the highest risk associated therewith. The list may be ordered from high-to-low risk, low-to-high risk, by risk value, etc. In some embodiments, each listed value and/or site point displayed on the map 1108 may include a link that, when selected, provides more detailed information for the one or more nodes associated with the selected link. In one embodiment, selecting the link may open a new window, provide another screen shot, filter results displayed, and/or navigate to another page.

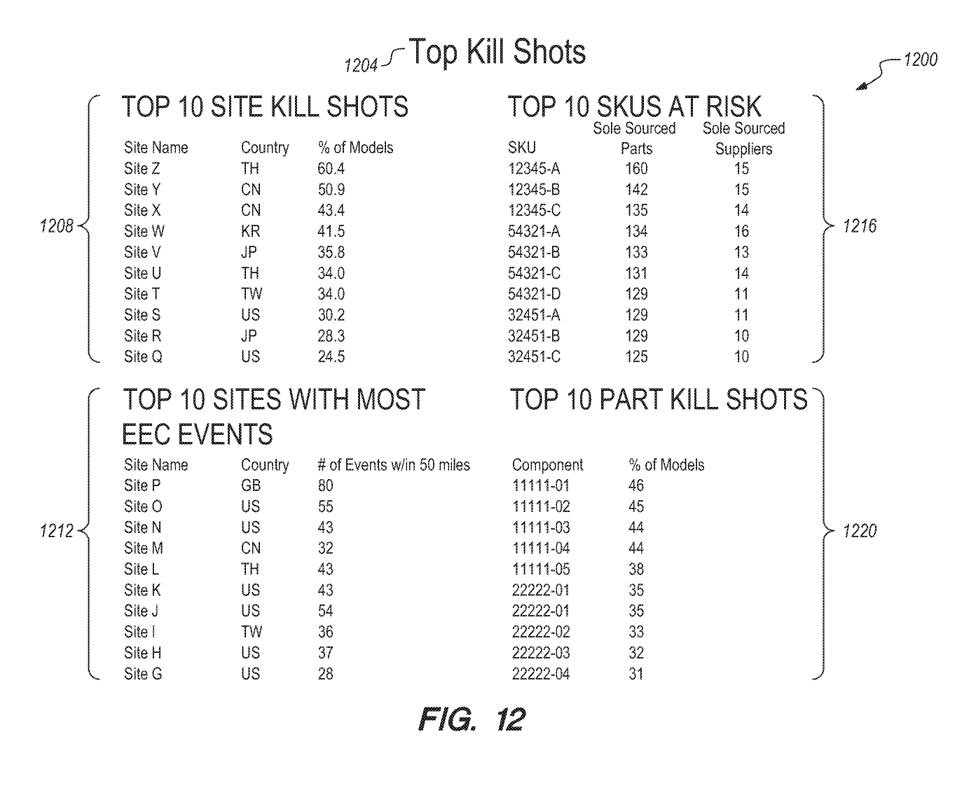

FIG. 12 depicts a screen shot 1200 output by the supply node risk analyzer 536 based on input from the supply node output analyzer 532. The screen shot 1200 shows the parts of a network having the highest probability of providing a kill shot to a supply and/or logistics chain.

In other words, the screen shot provides an outline of nodes, edges, and/or outputs of nodes that are critical to the operation of a supply and/or logistics chain. The screen shot 1200 shows the top ten site (e.g., nodes) kill shots 1208, the top ten sites with most EEC events 1212, the top ten part numbers, or stock-keeping units (SKUs), at risk 1216, and the top ten part kill shots 1220. The screen shot 1200 may include more or fewer sections than shown.

The top ten site kill shots 1208 may correspond to the sites in a supply and/or logistics chain that if they fail will cease operations of the chain. The top ten SKU s at risk 1216 may correspond to assemblies, subassemblies, or products that would be at risk as a result of a failure at a SPOF site or occurring at a kill shot site. For instance, if a failure occurs at a kill shot site then the output (e.g., a part, etc.) from the kill shot site may not be provided to a subsequent site (e.g., a receiving node, etc.) for including in a product (e.g., a SKU, etc.) and the product from the subsequent site cannot be made. The top ten part kill shots 1220 may relate to parts that if not available (e.g., due to failure or some other event, etc.) will cease the operations of a supply and/or logistics chain.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™ processors, ARM® Cortex-A and ARM926EJ-S™ processors, other industry-equivalent processors, and may perform computational functions using any known or future-developed standard, instruction set, libraries, and/or architecture.

The exemplary systems and methods of this disclosure have been described in relation to a computer network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example in one alternative embodiment, the methods, devices, and systems describe herein may determine nodal weaknesses in a computer network. In this example, nodes may correspond to a processor, resource, peripheral, or other device connected to the computer network. Specific examples of nodes include not only computers, laptops, and portable computational devices, such as tablet computers and smart phones, but also routers, servers, firewalls, switches, links, databases, and the like. Additionally or alternatively, the nodes may provide an output to at least one other node in the form of one or more bits. The edges may correspond to communications pathways between the nodes in the computer network. In one embodiment, the edges may comprise any type of known communication medium or collection of communication media and may use any type of protocols to transport messages and/or data between nodes in the network.

In another embodiment, any of the steps described in connection with FIGS. 8-9 can be performed manually, including input, such as inputting event information, information describing the supply and/or logistics chain, and the like.

In another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system comprising:
one or more processors;
a memory coupled to the one or more processors and storing a supply chain network diagram that describes suppliers and outputs provided by the suppliers in a supply chain, the supply chain network diagram comprising nodes connected by edges, each node corresponding to a supplier of the suppliers in the supply chain and each edge associated with an output provided by a first supplier to a second supplier corresponding to a first node and a second node connected by a respective edge;
a non-transitory computer-readable medium storing instructions which when executed by the one or more processors cause the one or more processors to perform:
identifying, from the supply chain network diagram, for each output of the outputs of supplier nodes, a number of the supplier nodes that receive the output from another supplier node, and a number of products in which the output is used based on a bill of materials associated for a product that identifies the outputs in the supply chain that are used to make the product;
for each output, assigning a rank of the output relative to other outputs in the supply chain network diagram, wherein the output is assigned a higher rank if the output is used in more products than the other outputs;
identifying, from the supply chain network diagram, for each supplier node of the supplier nodes, a number of first outputs of the outputs the supplier node provides to other supplier nodes in the supply chain network diagram, and a number of the other supplier nodes to which the supplier node provides the first outputs;
for each supplier node, assigning a rank of the supplier node relative to the other supplier nodes in the supply chain network diagram, wherein the supplier node is assigned a higher rank than another node, of the other supplier nodes, if the supplier node provides more outputs used in one or more products than another node, of the other supplier nodes, provides;
for each supplier node in the supply chain network diagram that receives at least one output of the outputs, determining a risk value for the receiving supplier node based on the rank of the at least one output, the rank of the supplier node that provides the at least one output, weather, a frequency of historical issues, and scarcity of supply; and
causing displaying a first graphical user interface on a computer display device including a map that includes markers at geographic locations of the supplier nodes, and in response to input specifying selection of one of the markers, causing displaying an interface element that includes a particular risk value of a particular supplier node and a particular number of outputs provided by the supplier node that corresponds to the selected marker.

2. The system of claim 1, wherein the non-transitory computer-readable medium further comprises instructions that, when executed, cause:
for each of the supplier nodes, determining whether a second output of the supplier node is provided by another supplier node of the supplier nodes;
designating the supplier node as a single point of failure (SPOF) when the second output is not provided by another supplier node of the supplier nodes;
determining a number of the supplier nodes that receive the second output when the second output is not provided by another supplier node of the supplier nodes;
generating a second graphical user interface including a map depicting a geographic location of the SPOF.

3. The system of claim 2, wherein the non-transitory computer-readable medium further comprises instructions that, when executed, cause determining whether another output of the supply chain is an alternate output of the second output.

4. The system of claim 3, wherein the second output is a metric part and the alternate output is an imperial part.

5. The system of claim 2, wherein the non-transitory computer-readable medium further comprises instructions that, when executed, cause:
identifying a product produced by the supply chain that comprises the second output;
generating a third graphical user interface including an identifier of the product in association with an indication that the product includes the second output provided by the SPOF.

6. The system of claim 2, wherein the non-transitory computer-readable medium further comprises instructions that, when executed, cause generating a third graphical user interface including a list of suppliers designated as SPOFs.

7. The system of claim 2, wherein determining whether the second output of the supplier node is provided by another supplier node of the supplier nodes comprises determining that the other supplier node is temporarily unable to provide the output.

8. The system of claim 7, wherein the non-transitory computer-readable medium further comprises instructions that, when executed, cause determining that the other supplier node is temporarily unable to provide the second output due to an extreme environmental condition (EEC), and in response, determining an impact of the EEC on the supply chain.

9. The system of claim 1, wherein the non-transitory computer-readable medium further comprises instructions that, when executed, cause generating a second graphical user interface including a list of outputs associated with a highest risk relative to the other outputs.

10. The system of claim 1, wherein the non-transitory computer-readable medium further comprises instructions that, when executed, cause assigning the risk value is based in part on scarcity or complexity of the output.

11. A method comprising:
storing a supply chain network diagram that describes suppliers and outputs provided by the suppliers in a supply chain, the supply chain network diagram comprising nodes connected by edges, each node corresponding to a supplier of the suppliers in the supply chain and each edge associated with an output provided by a first supplier to a second supplier corresponding to a first node and a second node connected by a respective edge;
identifying, from the supply chain network diagram, for each output of the outputs of supplier nodes, a number of the supplier nodes that receive the output from another supplier node, and a number of products in which the output is used based on a bill of materials associated for a product that identifies the outputs in the supply chain that are used to make the product;
for each output, assigning a rank of the output relative to other outputs in the supply chain network diagram, wherein the output is assigned a higher rank if the output is used in more products than the other outputs;
identifying, from the supply chain network diagram, for each supplier node of the supplier nodes, a number of first outputs of the outputs the supplier node provides to other supplier nodes in the supply chain network diagram, and a number of the other supplier nodes to which the supplier node provides the first outputs;
for each supplier node, assigning a rank of the supplier node relative to the other supplier nodes in the supply chain network diagram, wherein the supplier node is assigned a higher rank than another node, of the other supplier nodes, if the supplier node provides more outputs used in one or more products than another node, of the other supplier nodes, provides;
for each supplier node in the supply chain network diagram that receives at least one output of the outputs, determining a risk value for the receiving supplier node based on the rank of the at least one output and the rank of the supplier node that provides the at least one output, weather, a frequency of historical issues, and scarcity of supply; and
causing displaying a first graphical user interface on a computer display device including a map that includes markers at geographic locations of the supplier nodes, and in response to input specifying selection of one of the markers, causing displaying an interface element that includes a particular risk value of a particular supplier node and a particular number of outputs provided by the supplier node that corresponds to the selected marker.

12. The method of claim 11, further comprising:
for each of the supplier nodes, determining whether a second output of the supplier node is provided by another supplier node of the supplier nodes;
designating the supplier node as a single point of failure (SPOF) when the second output is not provided by another supplier node of the supplier nodes;
determining a number of the supplier nodes that receive the second output when the second output is not provided by another supplier node of the supplier nodes;
generating a second graphical user interface including a map depicting a geographic location of the SPOF.

13. The method of claim 12, further comprising determining whether another output of the supply chain is an alternate output of the second output.

14. The method of claim 13, wherein the second output is a metric part and the alternate output is an imperial part.

15. The method of claim 12, further comprising:
identifying a product produced by the supply chain that comprises the second output;
generating a third graphical user interface including an identifier of the product in association with an indication that the product includes the second output provided by the SPOF.

16. The method of claim 12, further comprising generating a third graphical user interface including a list of suppliers designated as SPOFs.

17. The method of claim 12, wherein determining whether the second output of the supplier node is provided by another supplier node of the supplier nodes comprises determining that the other supplier node is temporarily unable to provide the output.

18. The method of claim 17, further comprising determining that the other supplier node is temporarily unable to provide the second output due to an extreme environmental condition (EEC), and in response, determining an impact of the EEC on the supply chain.

19. The method of claim 11, further comprising generating a second graphical user interface including a list of outputs associated with a highest risk relative to the other outputs.

20. The method of claim 11, further comprising assigning the risk value is based in part on scarcity or complexity of the output.
